(19) United States
(12) Patent Application Publication
(10) Pub. No.: US 2012/0311454 A1
(43) Pub. Date: Dec. 6, 2012

(54) HEALTH AND SAFETY DATA MANAGEMENT SYSTEM

(75) Inventor: Christian Danis, Pincourt (CA)

(73) Assignee: HAZMAT SYSTEMS INC., Pincourt (CA)

(21) Appl. No.: 13/485,999

(22) Filed: Jun. 1, 2012

Related U.S. Application Data
(60) Provisional application No. 61/492,414, filed on Jun. 2, 2011.

(51) Int. Cl. G06F 3/01; G06F 17/30; G06F 15/16

(52) U.S. Cl. 715/738

(57) ABSTRACT

A health and safety data management system allowing quick and easy storage and organization of a company's health and safety information, as well as user-friendly and computerized employee access to this health and safety information from the shop floor. All the information is entered into the system via a web-based interface, and that information is then replicated to a plurality of remote, ruggedized touchscreen workstations via the web. A separate web-based interface allows emergency services personnel to access the health and safety information directly online for customers in their jurisdiction.

### TECHNICAL FIELD

The present invention relates generally to the field of workplace safety and more specifically to a health and safety data management system.

### BACKGROUND

Employee safety is an ever-growing preoccupation for business owners. Companies spend millions of dollars annually to help protect their employees from harm, as well as to protect themselves from possible lawsuits. With expensive budgets for health and safety, companies are constantly looking for new ways to enhance the protection of their most valuable assets: their employees.

A material safety data sheet (MSDS) is a form containing information regarding the properties of a particular substance, such as a chemical, chemical compound or a chemical mixture. This information may include physical data (melting point, boiling point, flash point, etc.), potential hazards associated with the substance (e.g. toxicity, health effects, reactivity, etc.), first aid, storage, disposal, protective equipment and spill-handling procedures, among other possibilities. MSDS sheets are commonly used in the workplace to ensure the safety of the workers, by cataloguing information on potentially hazardous substances and providing the workers and emergency personnel with procedures for handling or working with specific substances in a safe manner.

Typically, MSDS formats are dictated by national requirements, since a certain amount of uniformity in the content and format of the data sheets is important to ensure the usefulness of the sheets, particularly for emergency personnel, as well as to facilitate the job of maintaining and updating the MSDS sheets over time. For example, in Canada, the Workplace Hazardous Materials Information System (WHMIS) sets the requirements for MSDSs in workplaces and is administered federally by Health Canada. In the United States, the Occupational Safety and Health Administration (OSHA) requires that MSDSs be made available to employees for potentially harmful substances handled in the workplace, as well as to local fire departments and local and state emergency planning officials.

The collecting of data for the MSDSs, as well as the writing/revising/maintaining of the MSDSs, may be a service provided internally by a company for its own workplace or, alternatively, may be handled by an external service provider hired by the company.

One challenge faced by business owners is how to efficiently make the MSDSs accessible to the employees and emergency personnel, particularly in emergency situations when time can be a very critical factor. Internet-based solutions are known, whereby an on-demand MSDS library and various safety compliance programs designed for a particular company may be accessed online, from any Internet-connected computer. This may be useful in a laboratory setting; however, in certain work environments, such as a shop floor or a warehouse, computers cannot be present due to environmental factors (such as dust and temperature). Unfortunately, in this type of workplace, it is very difficult to provide workers with quick and easy access to MSDS information.

Furthermore, companies may need to provide their employees with additional safety-related information, such as lockout tagout information or procedures to follow in case of an emergency. If a company wants to provide their employees with a written document regarding a specific safety-related procedure and these employees do not have easy access to a computer, the company must currently resort to providing the employees with a printed copy of the document in a binder. Additionally, when employees do not have easy access to a computer, the company has no means of transmitting videos related to occupational health and safety to the employees. Such videos for example may be health and safety training sessions, refreshers on specific safety procedures or visual examples of how to proceed in specific situations (for example how to lockout tagout a specific machine), among many other possibilities and purposes, even going beyond health and safety information.

Consequently, there exists a need in the industry to provide an improved health and safety data management system.

### SUMMARY

In accordance with a broad aspect, the present invention provides a health and safety data management system, comprising a server in communication with a database storing data representative of health and safety information for a workplace of a customer, and at least one remote station connected to the server via a data communications network. The remote station is located in the workplace and provides access to the respective health and safety information via the server. The remote station includes a visual display and a processing unit coupled to the display, the processing unit operative to implement a graphical user interface for prompting a user to input commands and for displaying health and safety information to the user. The remote station also includes a housing unit containing the display and the processing unit, the housing unit formed of a resistant material capable to protect the display and the processing unit from environmental conditions in the workplace.

### BRIEF DESCRIPTION OF THE DRAWINGS

The invention will be better understood by way of the following detailed description of embodiments of the invention with reference to the appended drawings, in which:

FIG. 1 illustrates a login screen of the administrator user interface module implemented by the server of the health and safety data management system, according to a non-limiting example of implementation of the present invention;

FIGS. 2 to 26 illustrate various different viewing windows of the administrator user interface module implemented by the server of the health and safety data management system, displaying data representative of health and safety information associated with a particular customer and providing a plurality of user-selectable controls via which a user can edit and update the customer's health and safety data, according to a non-limiting example of implementation of the present invention;

FIGS. 27-29 illustrate a remote station (SafeStation) of the health and data management system, for installation in the customer workplace, according to a non-limiting example of implementation of the present invention;

FIGS. 30-60 illustrate various different viewing windows of the graphical user interface module implemented by the processor of a remote station of the health and safety data management system, displaying data representative of health and safety information associated with a customer and providing a plurality of user-selectable controls via which a user can search and view this data, according to a non-limiting example of implementation of the present invention; and

FIG. 61 is a conceptual illustration of a health and safety data management system, according to a broad embodiment of the present invention.

### DETAILED DESCRIPTION

The present invention is directed to a novel health and safety data management system, which ensures employee safety in the workplace by facilitating the way a company stores and accesses essential health and safety data. Advantageously, the system enables user-friendly computerized access to health and safety data for employees working in an unfavorable environment, simplifying employee intervention in the case of a crisis and providing a valuable tool for emergency personnel, such as the fire department.

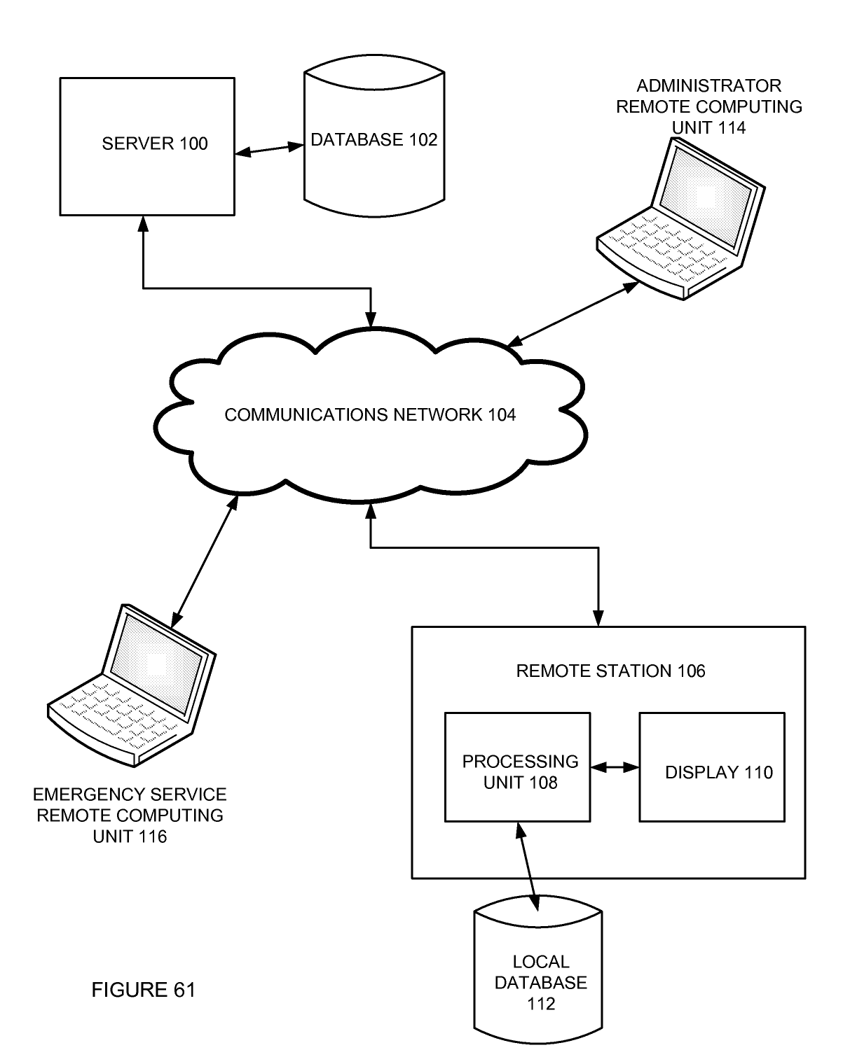

In a broad embodiment, the health and safety data management system includes a server 100 in communication with at least one database 102 storing data representative of health and safety information for a workplace of a customer or company, as shown in FIG. 61. This health and safety information may include MSDSs for the products and substances handled in the workplace, lockout tagout information, safety-related procedures to follow in case of an emergency, safety training sessions, among many other possibilities. The server 100 may be implemented by one or more of any type of suitable computing unit, including a personal computer, a workstation, a laptop, a PDA, etc. The database 102 may be implemented by any appropriate data storage medium, either standalone, within the same computing unit as the server or within a separate computing unit or system.

The server 100 is operative to implement an Internet-based graphical user interface (GUI), also referred to herein as an administrator user interface module, via which the health and safety database 102 of a particular customer or company can be accessed, input with data, revised, updated, etc., by authorized personnel of the respective company. This GUI can be accessed over the Internet (or other public or private data communications network) 104 from any computing unit 114 anywhere in the world.

At least one remote station 106 is connected to the server 100 via a data communications network 104, such as the Internet or any type of distributed cable or wireless network, where each remote station 106 is located in a workplace of a customer and provides access to the health and safety information stored in the respective customer's database 102 via the server 100.

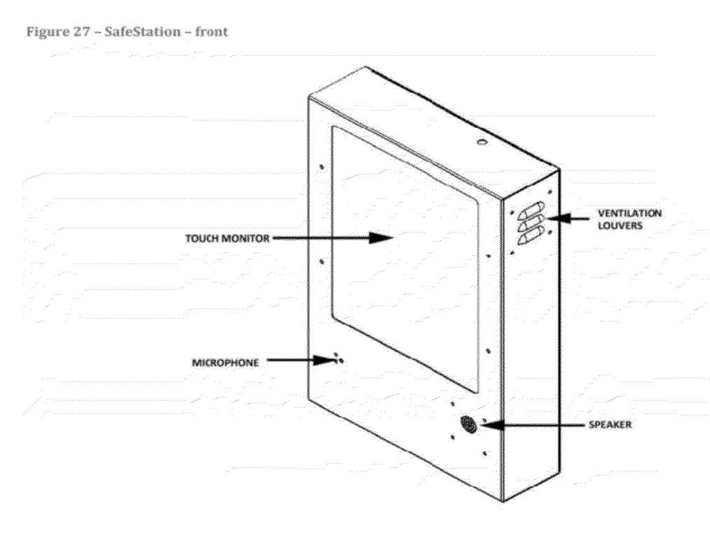

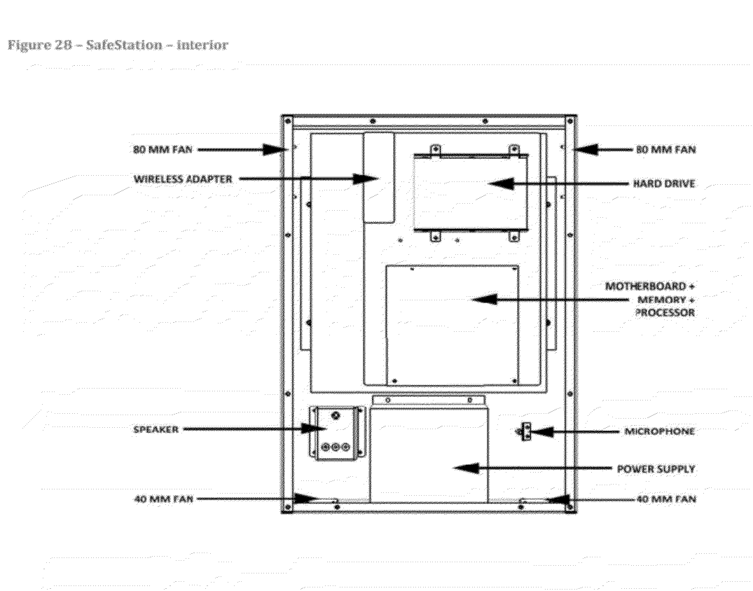

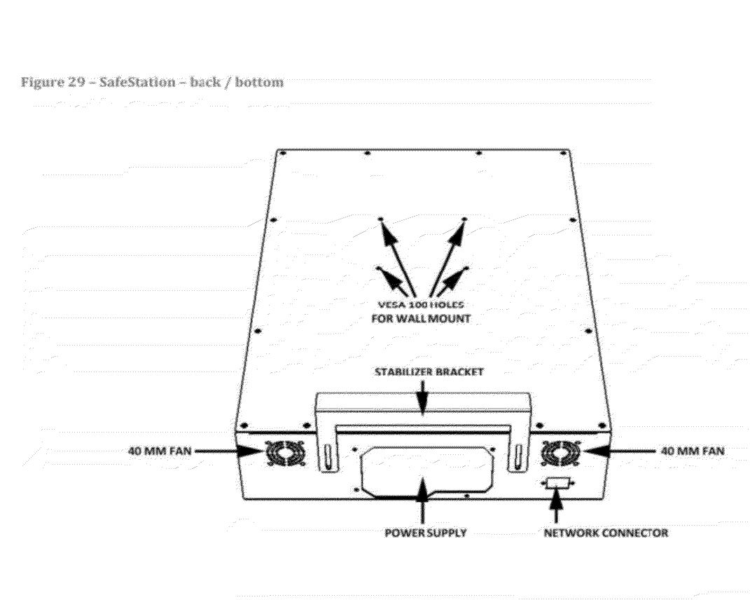

Each remote station 106 is a computing unit that includes a visual display 110, a processing unit 108 and a housing unit 200 (shown in FIGS. 27-29). The processing unit 108 is coupled to the display 110 and is operative to implement a graphical user interface for prompting a user for commands and for displaying health and safety information to the user via the display 110. The processing unit 108 is also operative to communicate with the server 100 via the data communications network 104, for receiving data therefrom and/or transmitting data thereto. The housing unit contains the display 110 and the processing unit 108, and is formed of a resistant material capable to protect the display 110 and the processing unit 108 from environmental conditions in the workplace, as will be discussed in further detail below.

In a specific, non-limiting example of implementation, each remote station 106 is in communications with a local database 112 storing a copy of at least a subset of the customer's health and safety data from the server database 102, where this subset of health and safety data may be specific to the particular site or location of the remote station 106 within the workplace.

Note that, in a variant embodiment, the server 100 is also operative to implement an emergency user interface module for providing remote emergency personnel, such as the police or fire department, with limited access to the health and safety information stored in a database 102 of a particular company in cases of emergency, on a jurisdiction basis. In other words, in response to a request from a remote computing device 116 of the emergency personnel, the server 100 is operative to implement a secondary Internet-based GUI (that takes the form of viewing windows displayed on a local display unit of the remote computing device 116), via which the emergency personnel must authenticate themselves and, if authenticated, may access the health and safety database 102 of a particular company when dealing with an emergency situation at the company. When prompted for authentication, the authentication data requested of the emergency personnel may include identification of the particular customer for which health and safety information is required.

Thus, the health and safety data management system includes various different components, each of which may be implemented in hardware, software, firmware or any combination thereof. When taking the perspective of a particular company or customer, these components can be broadly divided into three different categories:
a primary Internet-based graphical user interface (GUI), through which the customer or company (e.g. via a system administrator for the company) manages a database storing their respective health and safety data, including for example MSDS sheets;
a remote station for the company's workplace, which can be physically located in any work environment, including warehouses, manufacture shop floors, schools, hospitals, etc.; and
an optional secondary Internet-based GUI, through which emergency personnel, such as the fire department, can access the health and safety database of the company on a jurisdiction basis.

### Online Data Management System

The primary web interface allows companies to enter into a health and safety database (also referred to herein as a server database) 102 of the system all the necessary information that might be required in the case of a chemical-based emergency. This interface is also used to enter information such as emergency contacts and phone numbers, as well as safety-related procedures (including documents and videos). This information is entered easily via a GUI, which is accessible from a computing unit located anywhere in the world, via the Internet. The graphical user interface includes a plurality of clickable controls that can be activated or selected by the user with a user-controllable pointing device (e.g. a mouse, a trackpad or touchpad, a click wheel, etc.). Various other, different types of user-activatable controls are also possible, including for example drop-down lists. Each control of the GUI may be in an active or a deactivated state, where in the active state the control is selectable by the user and in the deactivated state the control is unavailable for selection by the user. In a particular example, one or more controls on a screen of the GUI may only become active if and when another control is selected by the user.

Note that the primary and secondary web interfaces discussed below and shown in the drawings are for illustration only and may vary greatly both in layout and content, depending on the particular application and/or the architecture/design/capability of the graphics processing entity.

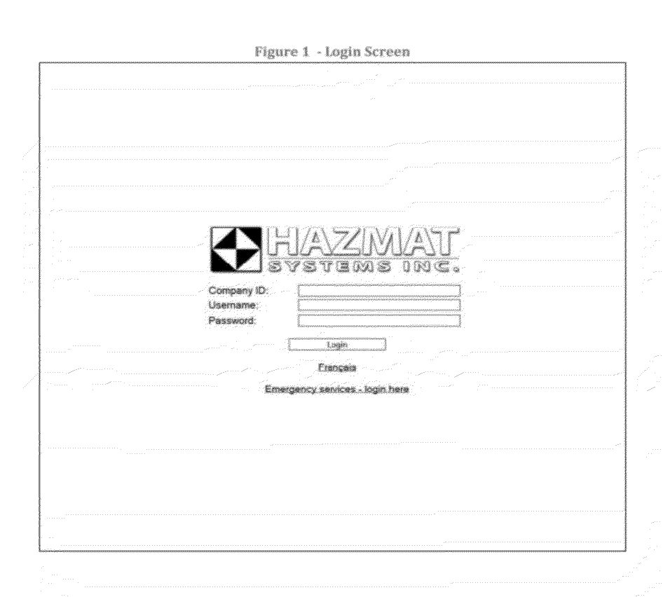

In a specific, non-limiting example of implementation of the present invention, a user or administrator first logs in to a web site of the health and safety data management system by entering a predefined company name, as well as a username and predefined password, as illustrated by the sample screenshot shown in FIG. 1.

Once logged into the system, the user can manage the entire health and safety database of the company directly from the web interface.

### Products

Once logged into the system, the user may be greeted with a customizable text, as well as for example the following information: the status of each remote station associated with the company, a list of products associated with the company that have MSDSs that are expired (e.g. over 3 years old), a list of products associated with the company that have MSDSs that are almost expired (e.g. between 2 years 10 months old and 3 years old), and a list of products that are incomplete (e.g. missing a MSDS in pdf format in one of the required languages).

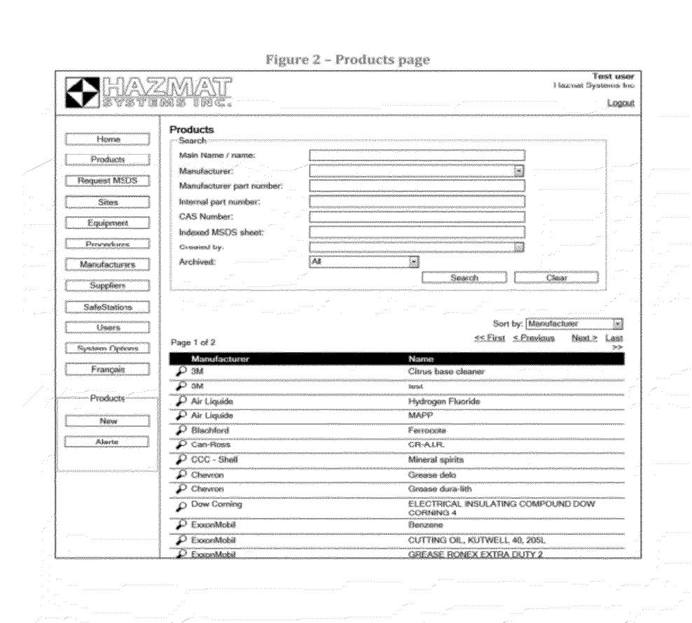

On the product page, a grid provides the user with a list of products that have been entered for the company, and search criteria at the top of the grid allows the user to quickly find a specific product, as illustrated by the sample screenshot shown in FIG. 2.

By clicking on the down arrow next to a product, the user can see additional information regarding the MSDS for this specific product, such as for example the date issued for an MSDS in a specific language.

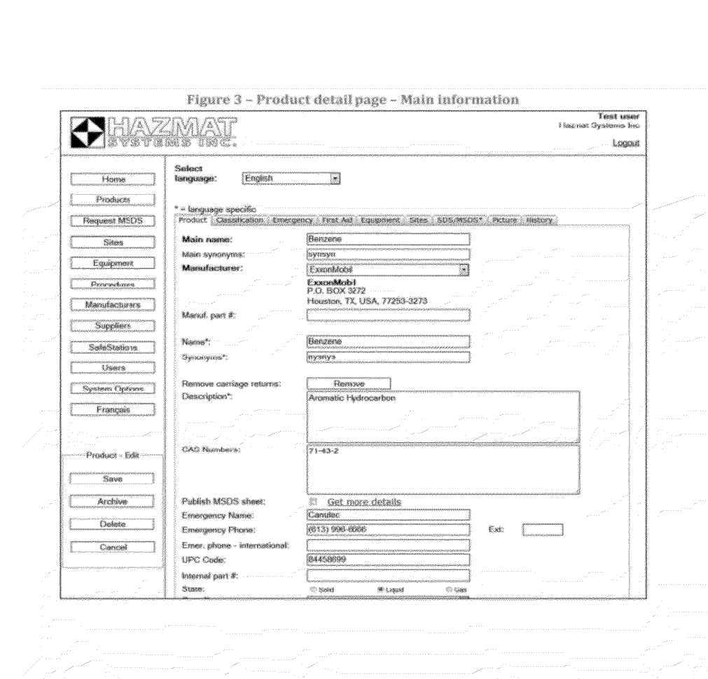

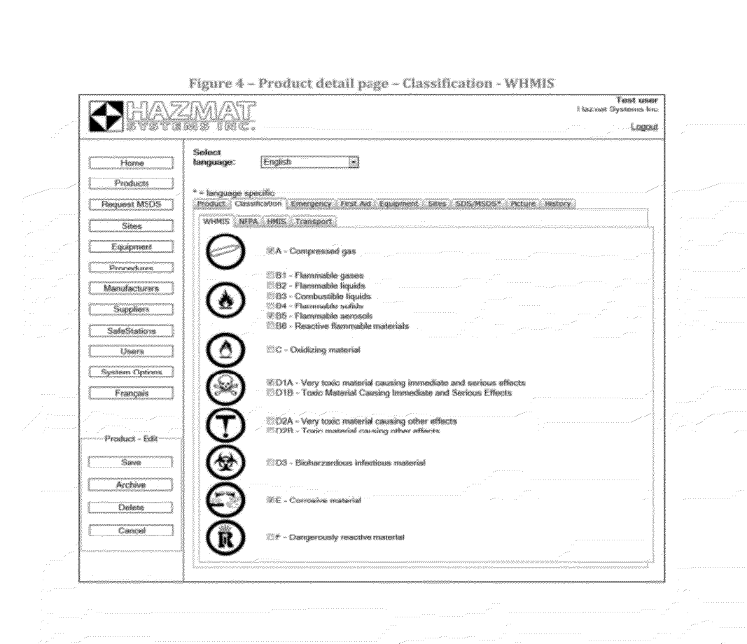

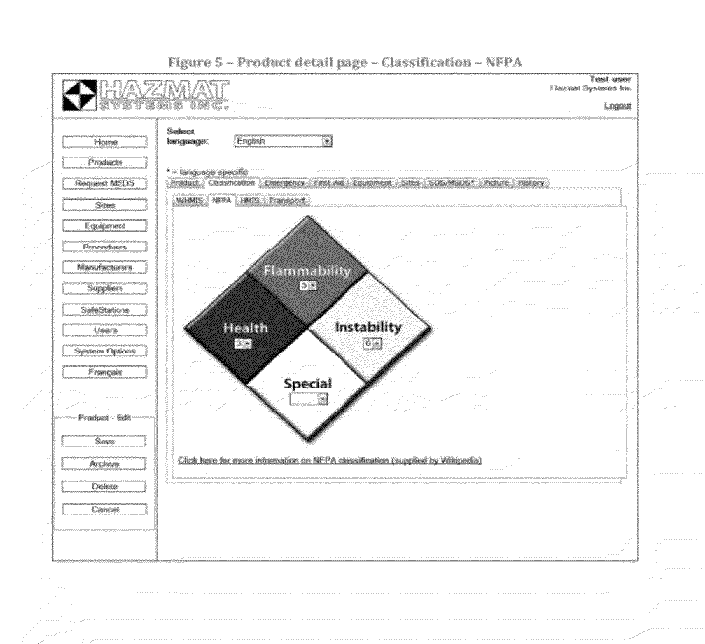

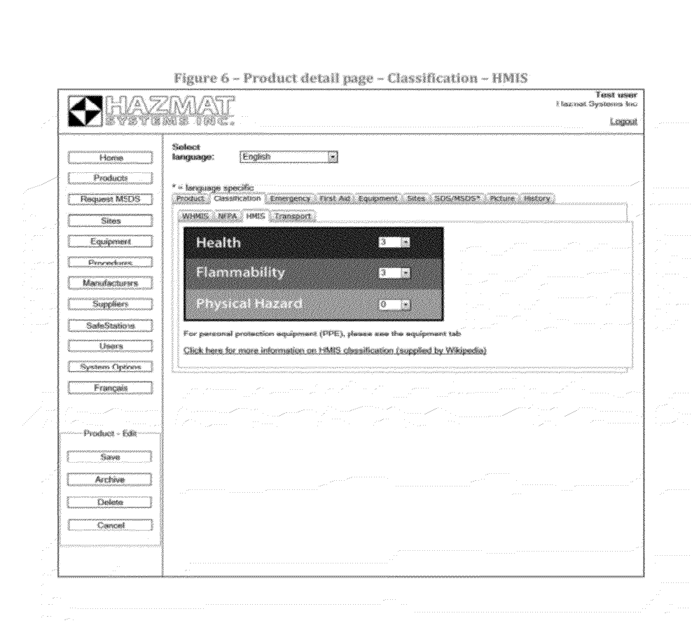

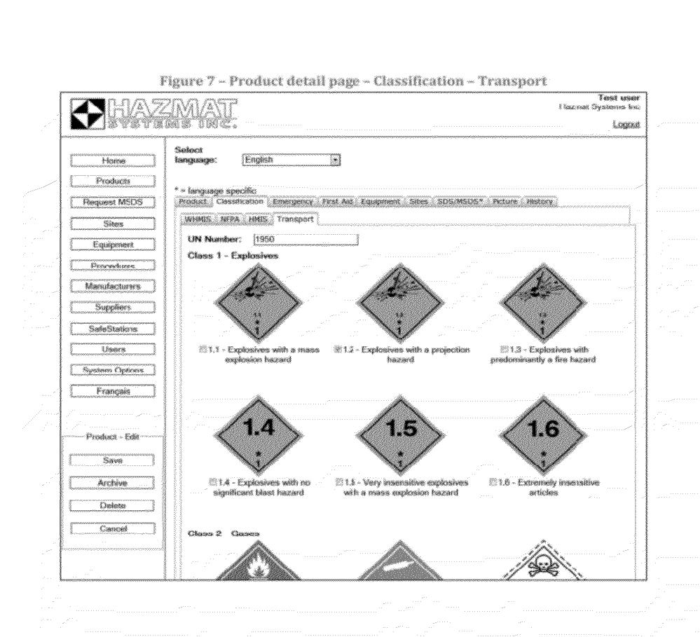

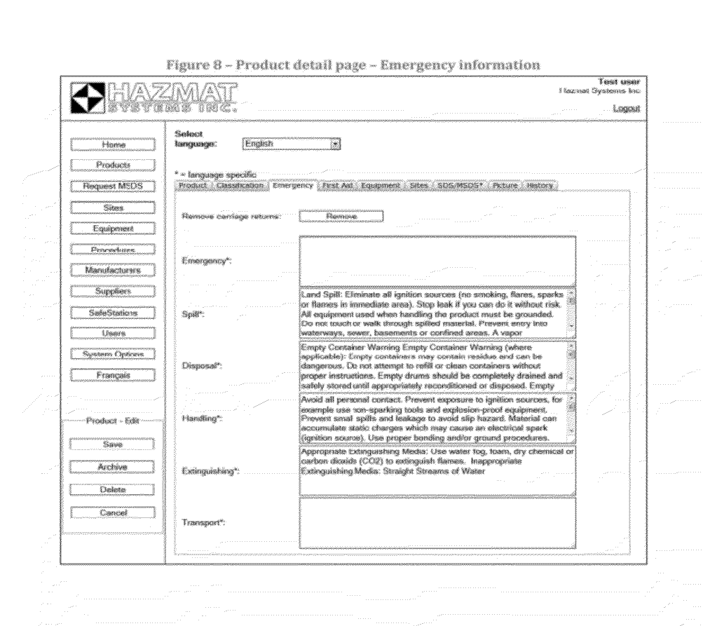

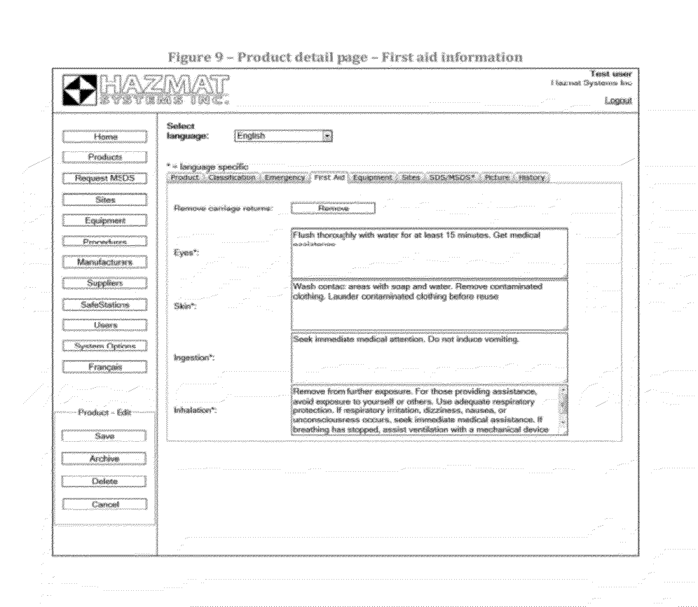

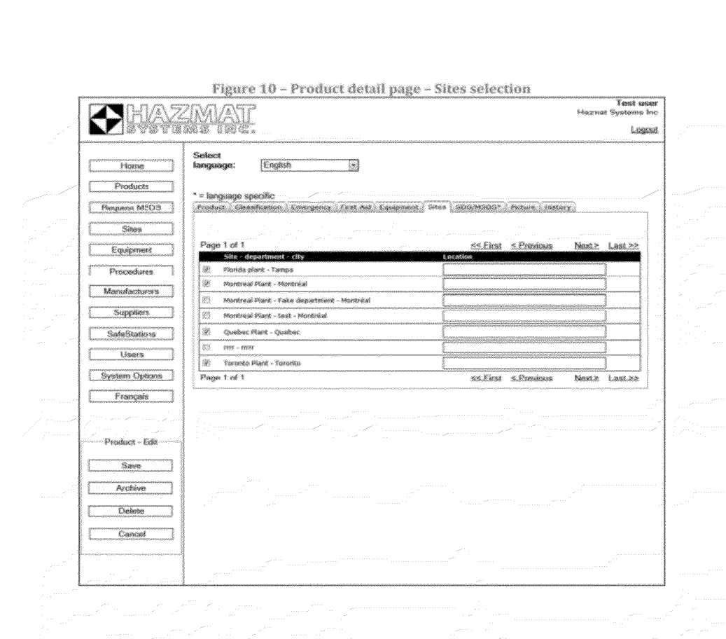

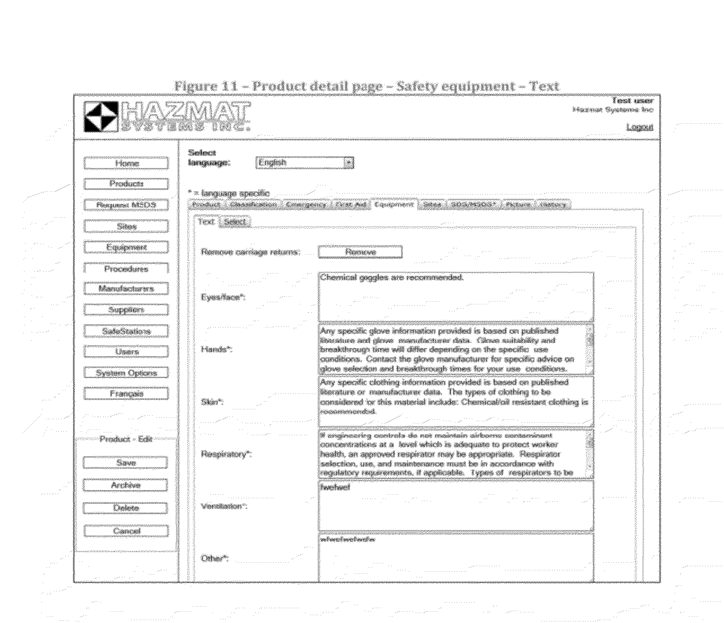

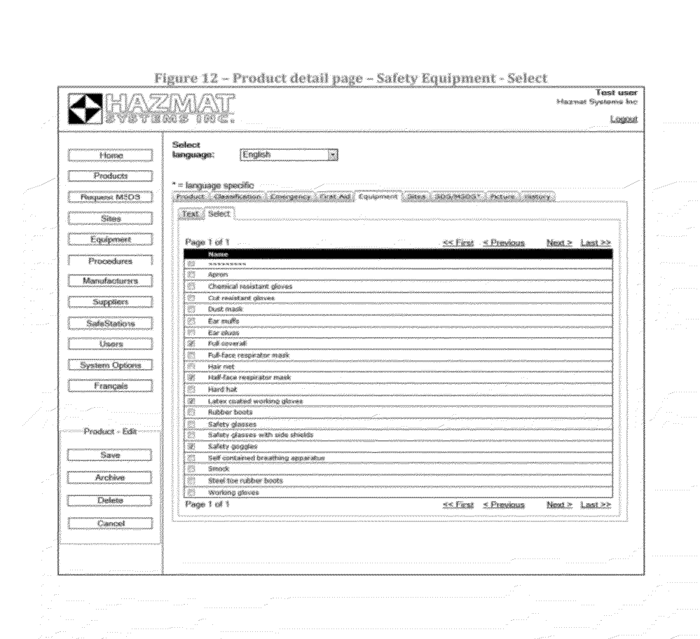

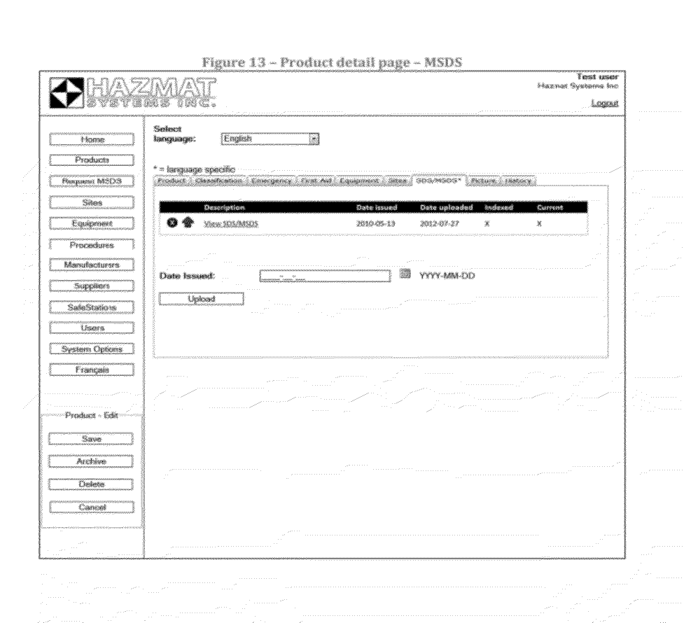

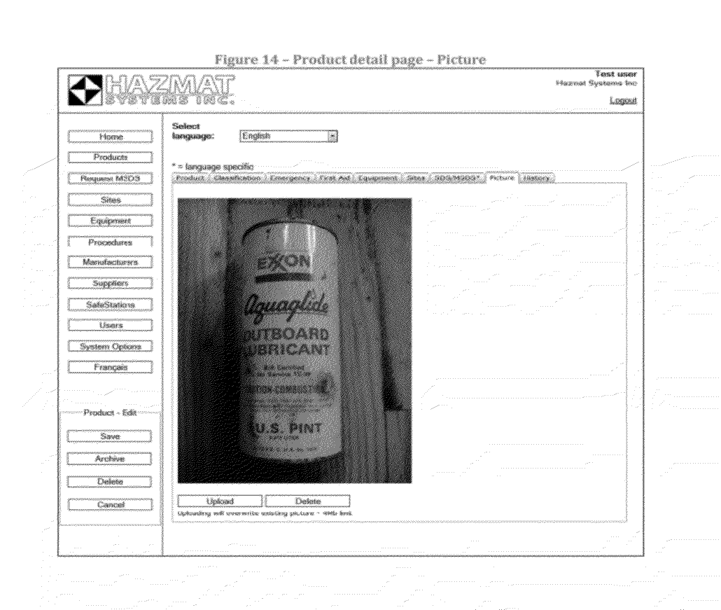

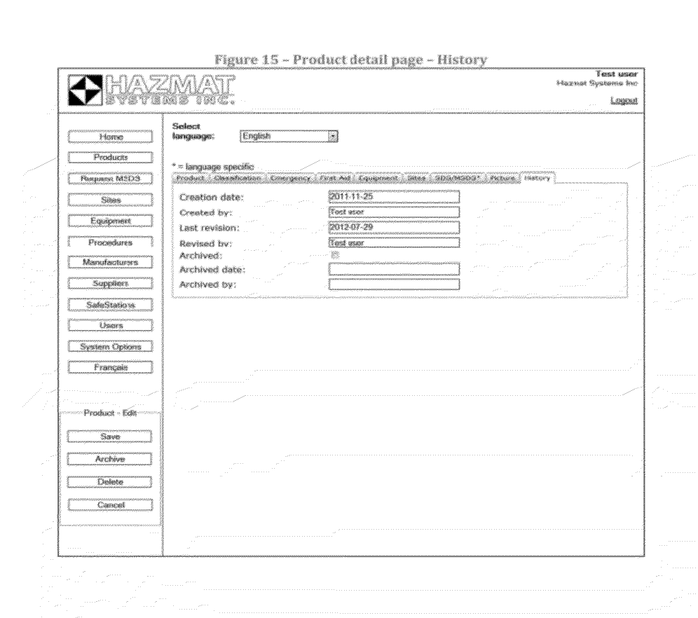

By selecting a Product—Edit control (e.g. a magnifying glass icon next to a product name), the user can enter the details of a specific product. The information specific to a particular product that may be entered by the user may include, for example:
product information (e.g. name, description, synonyms, CAS numbers, part numbers, manufacturer and supplier information, etc.) (see screenshot sample shown in FIG. 3);
class information (e.g. WHMIS (see FIG. 4), NFPA (see FIG. 5), HMIS (see FIG. 6), Transport (see FIG. 7), GHS, etc.);
handling information (see screenshot sample shown in FIG. 8);
first aid information (see screenshot sample shown in FIG. 9);
sites on which this specific product is used (see screenshot sample shown in FIG. 10;)
safety equipment used to manipulate this specific product, both as text (see screenshot sample shown in FIG. 11) or selected from the specific safety equipment entered in the system (see screenshot sample shown in FIG. 12);
the actual material safety data sheet uploaded in pdf format (see screenshot sample shown in FIG. 13);
a picture of the product (see screenshot sample shown in FIG. 14);
the history of this product (see screenshot sample shown in FIG. 15);
etc.

After a certain time delay required for processing the input data and updating the company's health and safety database, the user-specified product information will be available and accessible via remote stations (also referred to herein as workstations) within the workplace, which allow quick and easy access to the information in the database directly from the shop floor.

The MSDS sheet tab allows the user to quickly upload from their computer a MSDS sheet in PDF format, both in French and English, as illustrated by the sample screenshot shown in FIG. 13. This sheet can then be viewed by any user logged in with the same company code, or can be viewed at the remote station(s). One advantage of the management system is that, if an uploaded MSDS contains selectable text, that text is automatically indexed for easy searching. For example, if a PDF sheet contains the word “cancerous” and if that sheet is indexed by the system, a user can easily find a record of all sheets which contain the word “cancerous” by entering the word in the Indexed MSDS Sheet field in the search grid (see sample screenshot of FIG. 2).

### Request MSDS

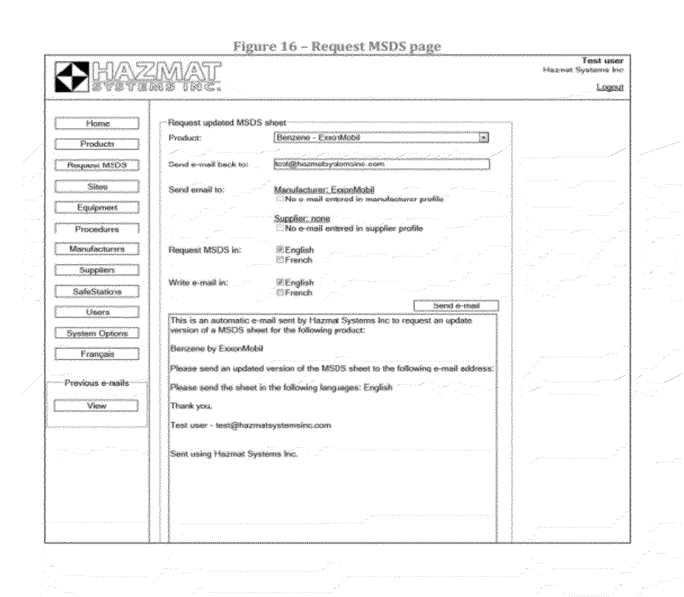

When a user clicks on the Request Update button in the MSDS tab on the Product—Edit page (see screenshot sample shown in FIG. 13), or if he clicks on the Request MSDS button in the main navigation bar on the left, he is taken to the Request MSDS page (see screenshot sample shown in FIG. 16), from where he can automatically send out an e-mail to the manufacturer of the product for which he needs an updated MSDS.

### Sites

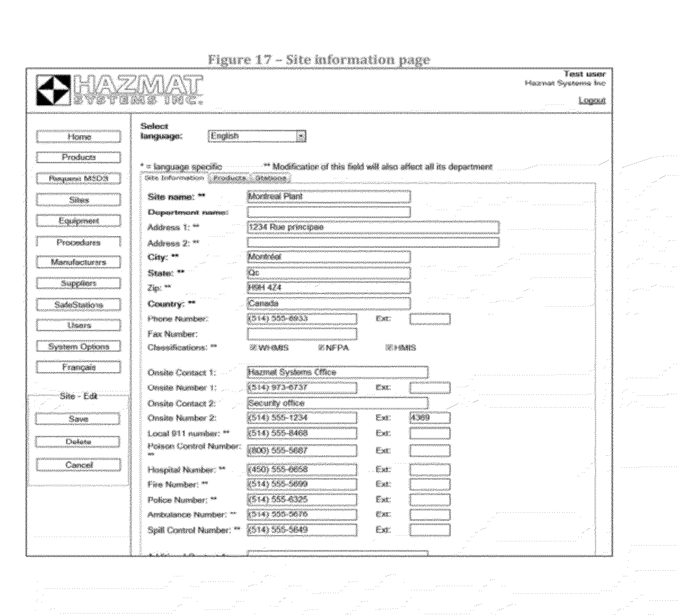

From the sites screen, the user can enter information pertaining to a specific site or department, such as address information for the site, emergency contacts onsite and emergency phone numbers (police, fire, poison control, ambulance, etc.) for that site, as illustrated by the sample screenshot shown in FIG. 17.

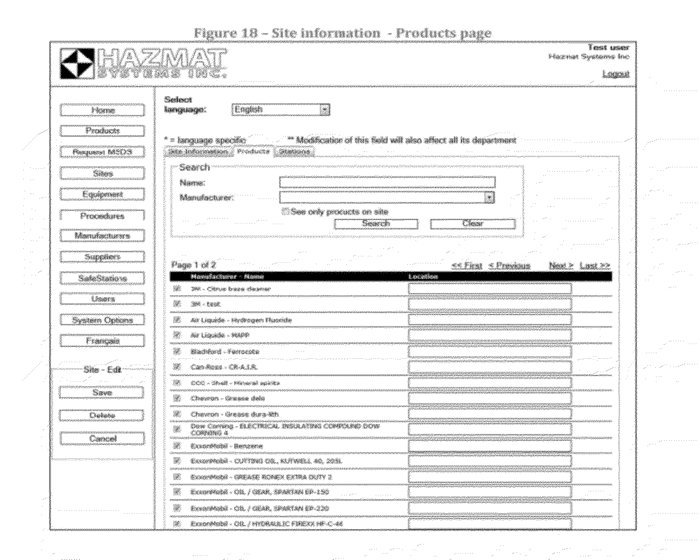

On the products page, the user can select or specify which chemicals are actually stored onsite. This allows the user to know exactly which products are onsite, and only information for these products will be sent to the remote workstations. The user can also indicate the location inside a specific site where that product is located (for example, shelf or section number), as illustrated by the sample screenshot shown in FIG. 18.

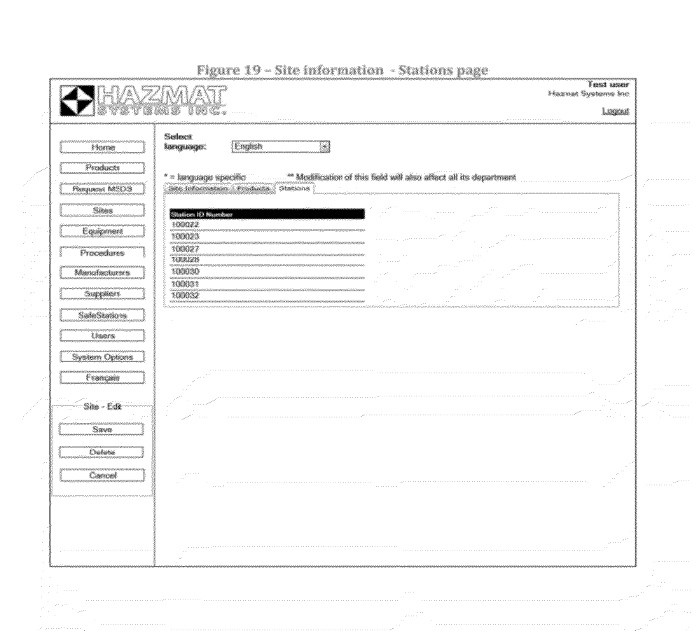

The stations tab allows the user to see and select which remote station is actually onsite, as shown in FIG. 19.

### Equipment

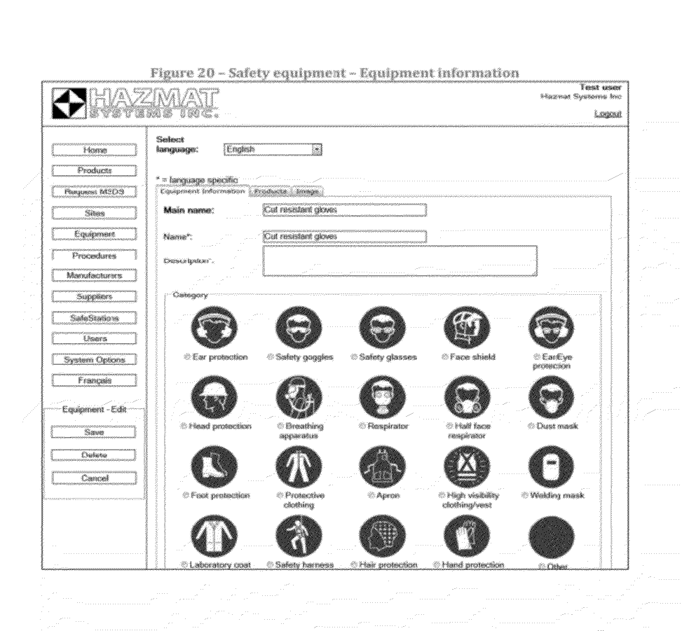

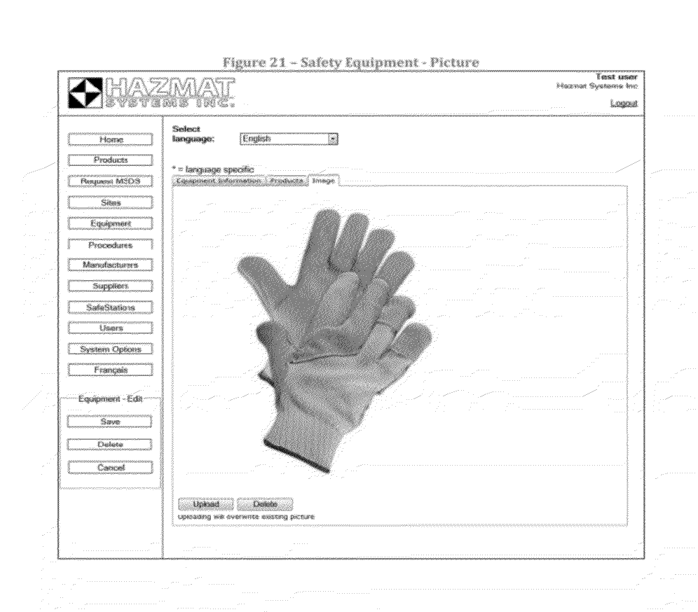

The equipment section allows the user to enter information regarding safety equipment used to manipulate or protect an employee from certain chemicals, including a description of the equipment as well as the category, as shown in the sample screenshot of FIG. 20. The user can even upload a picture of that product for easy reference by employees, as illustrated by the sample screenshot shown in FIG. 21.

### Procedures

The procedures section allows the user to enter information regarding health and safety procedures for the employees.

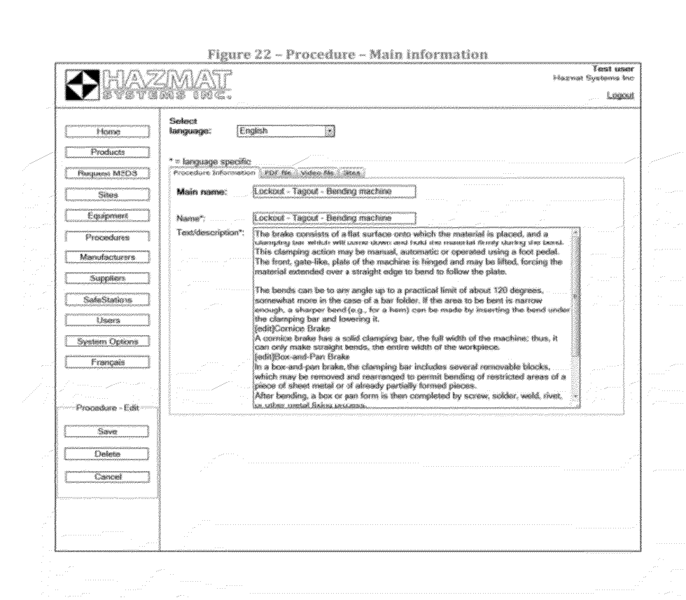

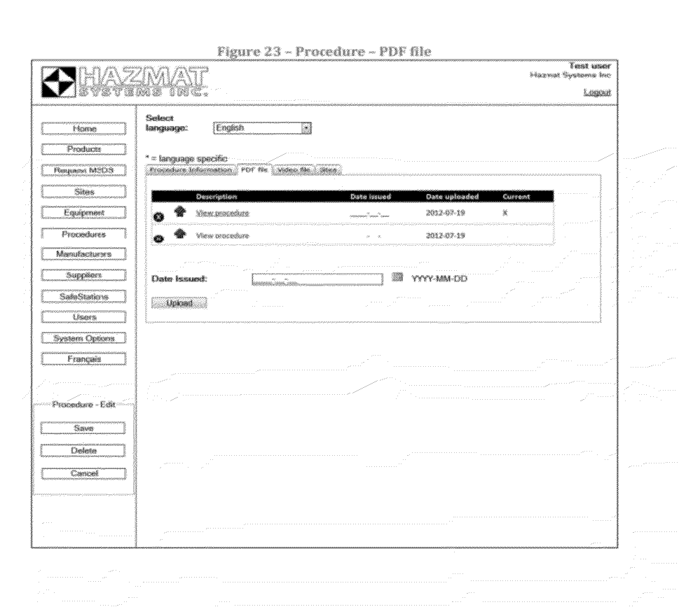

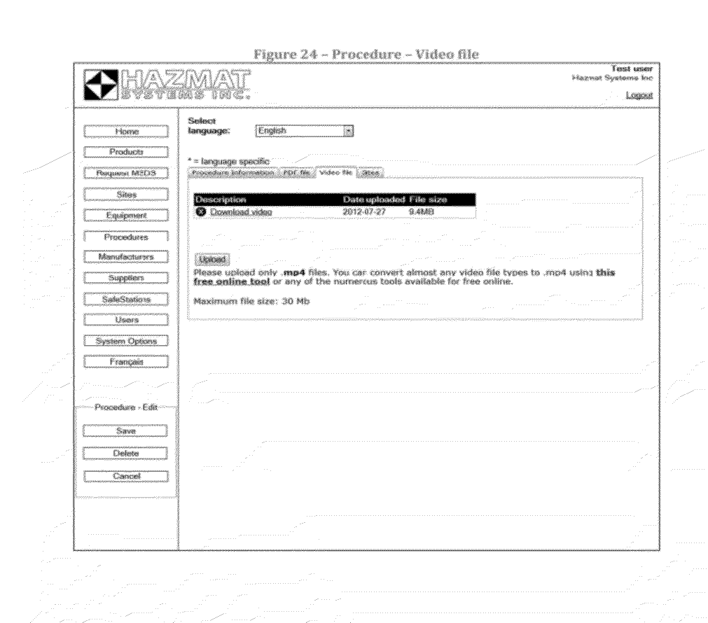

The user is able to enter instructions for each specific procedure (see FIG. 22), can upload a specific document regarding a procedure (see FIG. 23) and can even upload a video pertaining to a procedure (see FIG. 24).

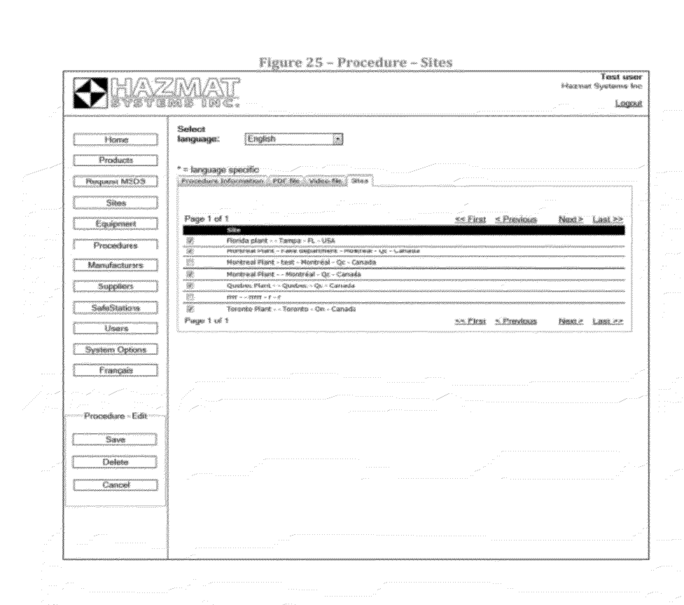

Since procedures can vary depending on the site (e.g. the procedure to follow if someone is electrocuted may not be the same for different sites or even departments of the company), the user can identify which site/department each specific procedure applies to, as illustrated in the sample screenshot shown in FIG. 25.

Each procedure can also be set up such that, when a video or document of the procedure is viewed on a remote station, the viewer is prompted to identify him or herself to the system (either before or after the document/video has been viewed). As such, when a document or video is training-related, the company may track which employees have completed the training. In addition, the procedure may be designed such that a script is presented to the viewer after viewing a particular document or video of the procedure, where this script may for example consist of a set of questions to be answered by the viewer, designed to certify that the viewer has understood the document/video.

### Stations

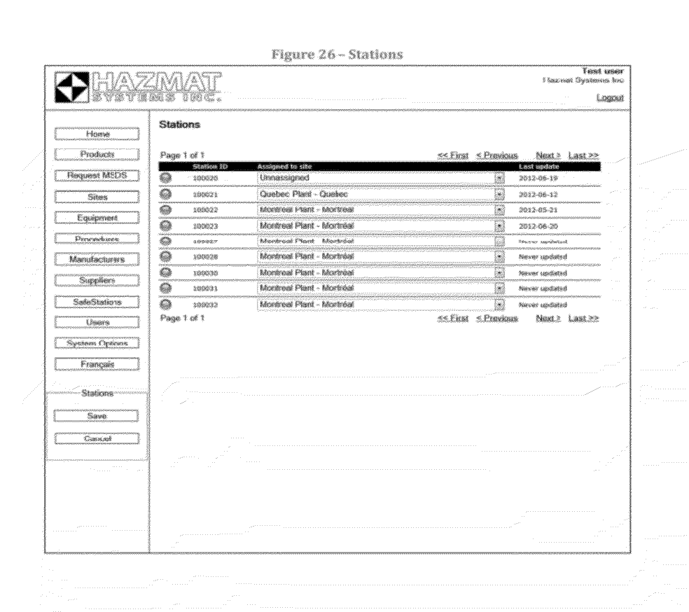

Each remote station (also referred to herein as a SafeStation) is associated with a unique representative code, also referred to as a station ID. Each station is then associated to a client (or company) and within that client's workplace, the station is associated to a specific site or department, as illustrated by the sample screenshot shown in FIG. 26. In so doing, it is possible to provide the station's local database with only information that is relevant to the respective site or department in the workplace.

### SafeStation

Specific to the present invention, the remote stations of the health and safety data management system provide quick and easy access to MSDS information and other health and safety information required by the employees directly in the workplace, even when this workplace is a warehouse or a shop floor. A non-limiting, exemplary prototype of the SafeStation is illustrated in the pictures shown in FIGS. 27-29. Various different designs and layouts of the SafeStation are also possible and included in the scope of the present invention.

The SafeStation is characterized by a ruggedized housing unit 200 that contains the processing unit 108 and the display unit 110 (shown in FIG. 61), among other possible components such as a memory, a speaker, a microphone, network connectors, etc. This housing unit 200 is formed of a rigid material, such as a metal or hard plastic, and is designed to withstand the harsh and unfavourable conditions of warehouse or shop floor environments, including excessive dust and temperature, that would typically be detrimental to a computer. The SafeStation uses state-of-the-art touch screen technology (e.g. touch screen technology used in smart phones), whereby a user can use his finger as a mouse to input and/or request data via the graphical user interface presented on the screen or display of the SafeStation. In so doing, the user can access all of the health and safety information pertinent to his or her location in the workplace. This design makes the SafeStation extremely easy to use, even for someone who has never touched a computer, and allows users to rapidly find the important information that they may need either in an emergency, to ensure their safety, or for training purposes. Within a few seconds, the user can view the safety information that was previously entered in the online portion of the system directly onscreen.

Some of the information that is accessible on the SafeStation includes:
MSDS related information such as product name, description, CAS numbers, part numbers, manufacturer, handling information, extinguishing information, classification, such as WHMIS, NFPA, HMIS, Transport or GHS, first aid information, the actual MSDS in a pdf format, pictures, etc;
Safety procedures, including text, documents and videos;
Communication information and phone numbers for emergency services and manufacturers;
etc.

Each SafeStation set up in the workplace is much more than simply a local access point to the company's health and safety database. For example, the SafeStation may be equipped with a built-in speaker and microphone. Using the communication module integrated in the GUI and communicating using the built-in speaker and microphone, a user may quickly and easily get in touch with a number of emergency services, such as 911, police, fire, ambulance, poison control, hospitals, internal emergency personnel, etc. The communication center can also be used to get in touch with all the manufacturers that have a North American phone number entered in the system. In a specific, non-limiting example, all such communications via the SafeStation are IP based via the Internet, so there is no need for a phone line to be installed at the station and no long-distance charges either.

Installation of these remote stations in the workplace is simple and straightforward, since the SafeStations are preconfigured at the time of manufacture, before leaving the factory. The SafeStation is permanently or removably mounted by any appropriate means in any appropriate location, for example it can be hung on a wall using the provided wall mount, screwed to a post or placed on a shelf. The SafeStation can then be plugged in to a standard 120 Volt outlet and either plugged into a network cable or configured to access a wireless network via a wireless card.

Firewalls and network ports do not cause any problems in most cases, since the SafeStation is designed to update itself using standard internet ports. In a specific, non-limiting example of implementation, the database software used to build the SafeStation is Microsoft's SQL server, which now offers the possibility of updating the data through the web on a standard secure internet port.

Since it is risky to depend on an internet connection when an emergency occurs, each remote station is in communication with a local database 112 (shown in FIG. 61) storing all of the information pertinent to its site. Furthermore, the local database 112 of each remote station within the workplace is kept up to date with periodic updates from the server database 102, all done automatically over the web.

### Operation

The following description of the operation of the SafeStation is exemplary, for the sole purpose of illustrating the possible functionality of the SafeStation. Various different functionality and operations/steps are also possible, without departing from the scope of the present invention.

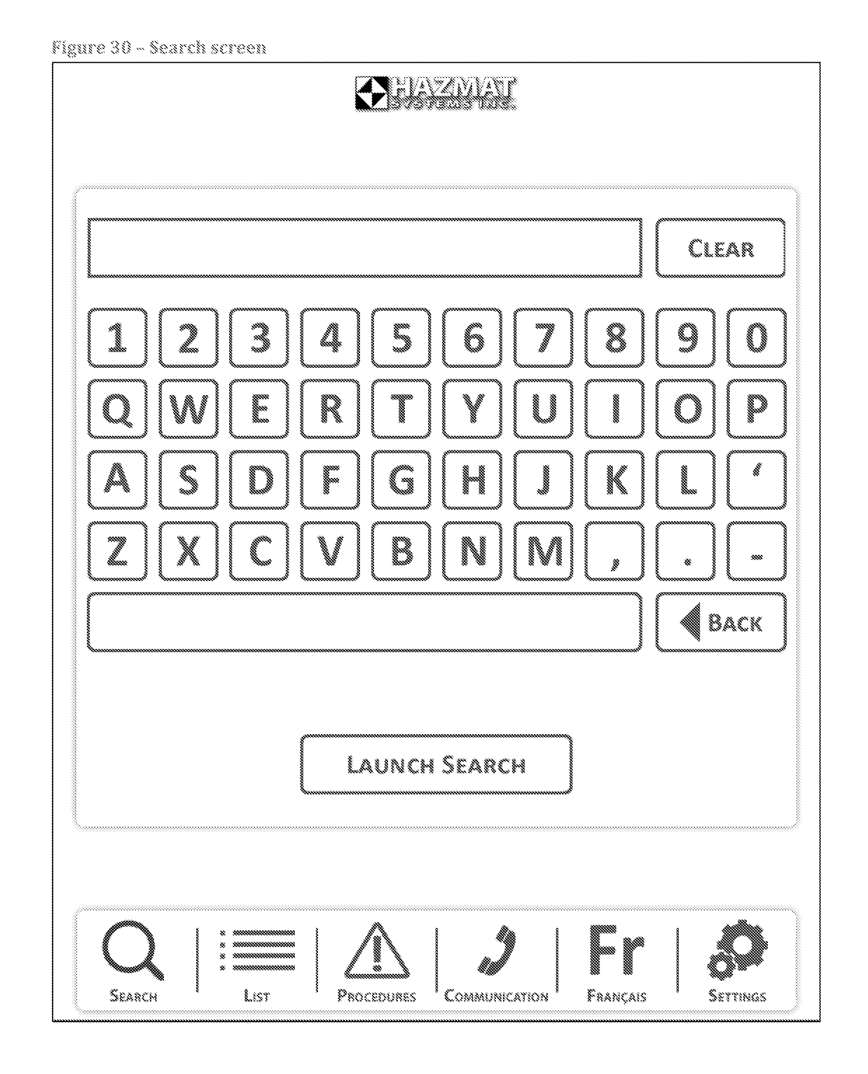

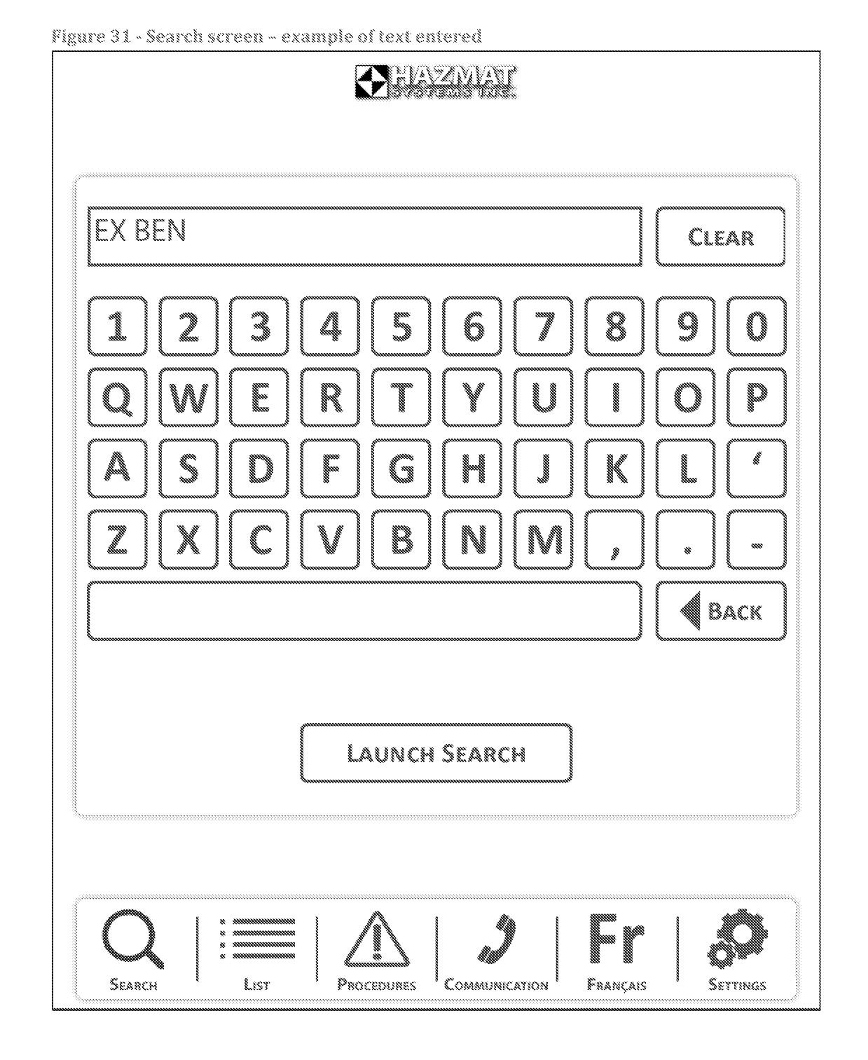

In a non-limiting example of implementation of the present invention, as soon as a SafeStation is plugged in and turned on, a graphical user interface loads up on the station's screen. The search page allows a user to search for a specific product, as illustrated by the sample screenshot shown in FIG. 30. The user does not need to specify a specific field to be searched (e.g. manufacturer name, product name, synonyms, description); rather, the user simply enters a search string using the onscreen keyboard and hits the “launch search” button, which can save precious time in the case of an emergency. An example of text entered can be seen in FIG. 31, in this case, “EX BEN”, use to locate Benzene manufactured by ExxonMobil.

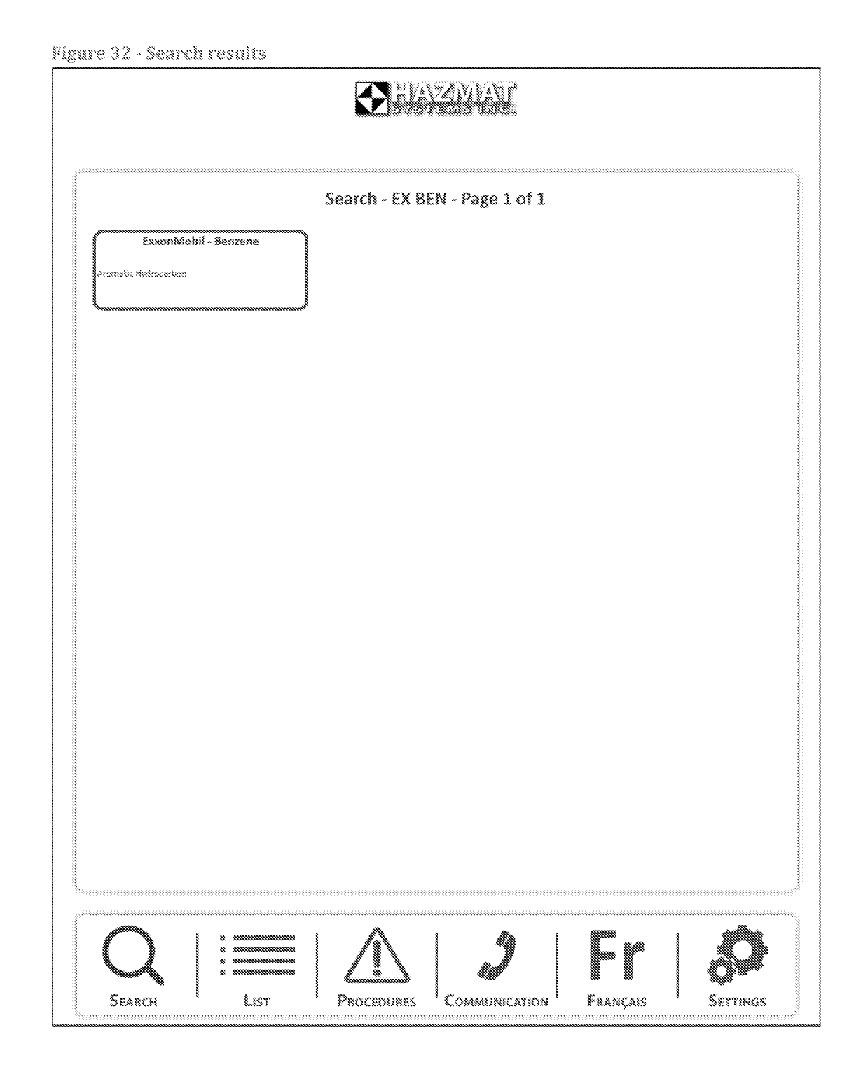

The search results screen, illustrated by the sample screenshot shown in FIG. 32, shows the search results based on the information entered in the search screen, showing each product with the manufacturer name, product name and description. The results may be separated in pages, showing a specific number of products per page, with the previous and next buttons at the bottom of the screen being responsive to the user's touch to navigate from page to page.

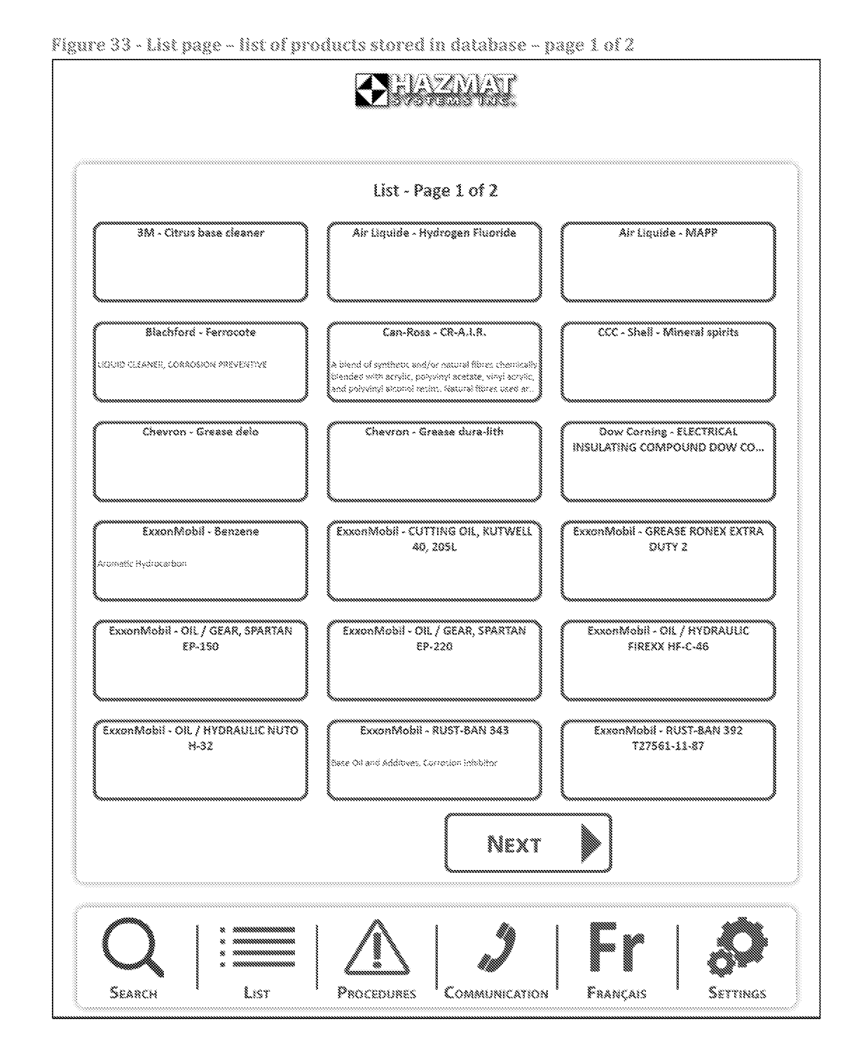

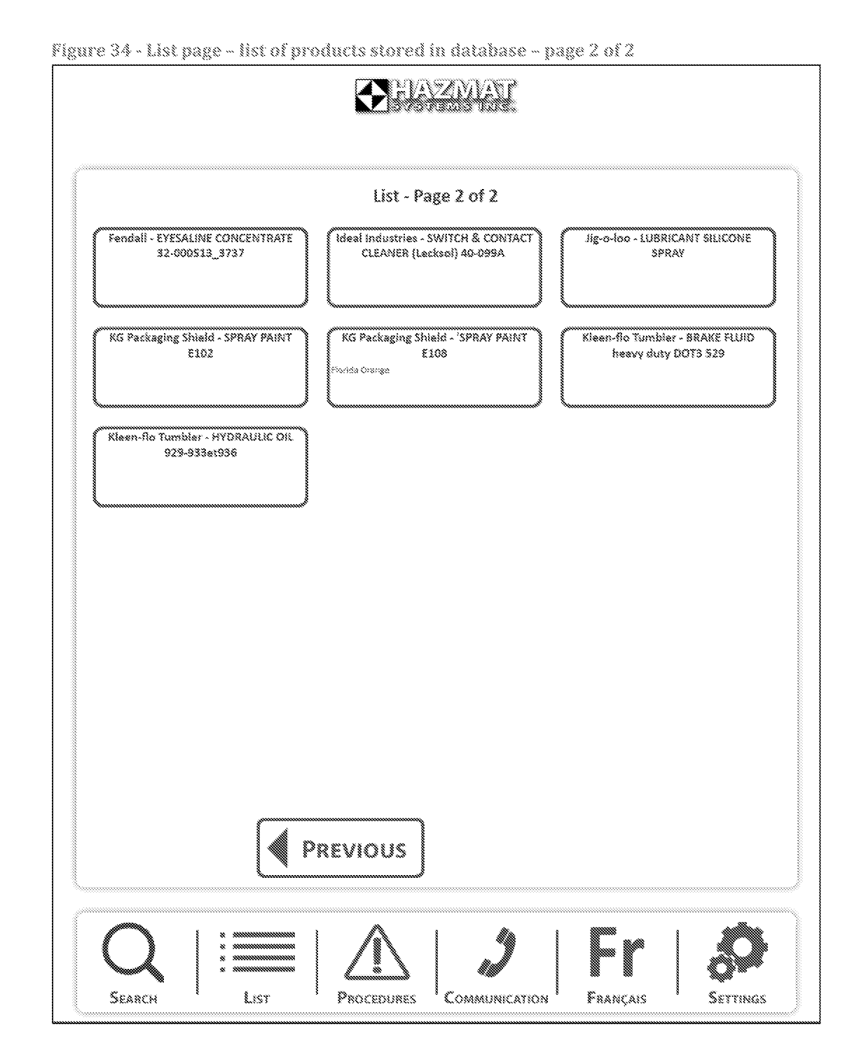

If no information is entered in the search screen or if the user hits the list button on the navigation bar at the bottom of the screen, a list of every chemical available at the respective site is displayed on the screen, as illustrated by the sample screenshot shown in FIGS. 33 and 34.

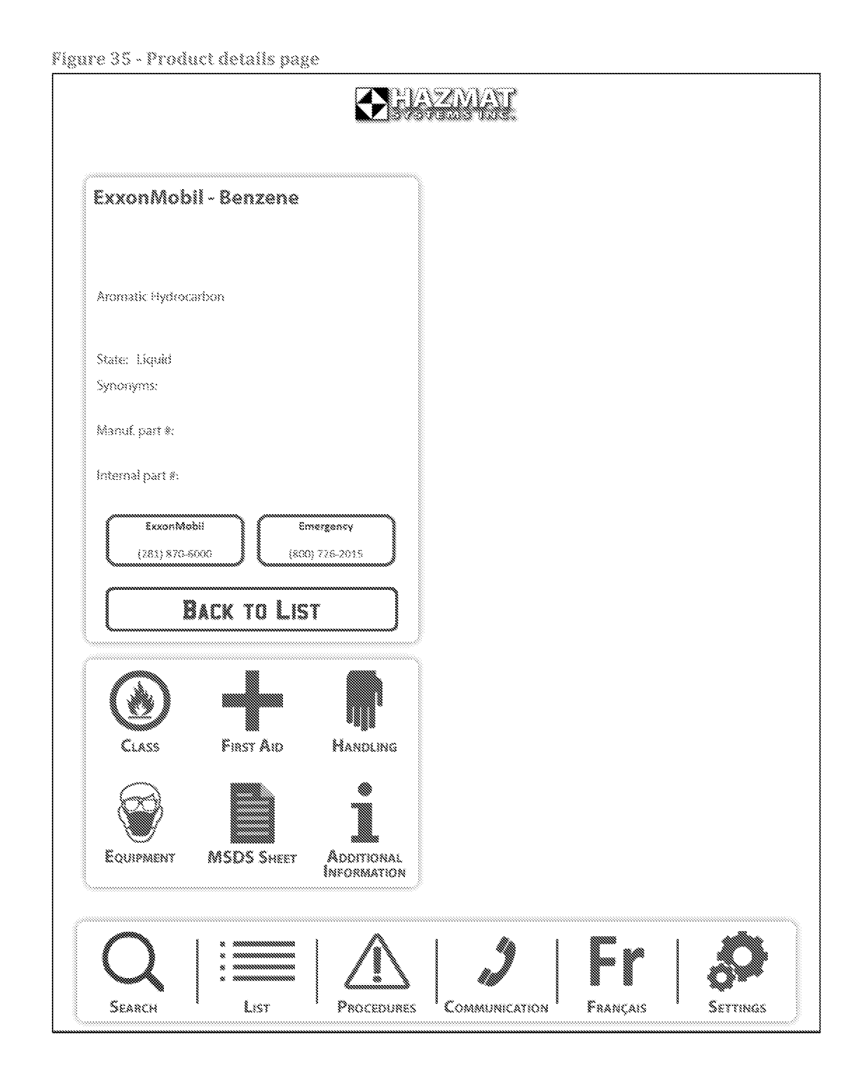

Once the user clicks on a particular product, the details page is displayed on the screen of the SafeStation, giving the user quick and easy access to all the information on that particular product, as illustrated by the sample screenshot shown in FIG. 35. The information found here was previously entered in the web portion of the system, and was replicated to the SafeStation. The details page includes information such as the product name and description, the state, different synonyms, manufacturer part number and internal part number, as well as possibly additional useful information. This information is maintained on the screen, regardless of which subcategory may be chosen by the user.

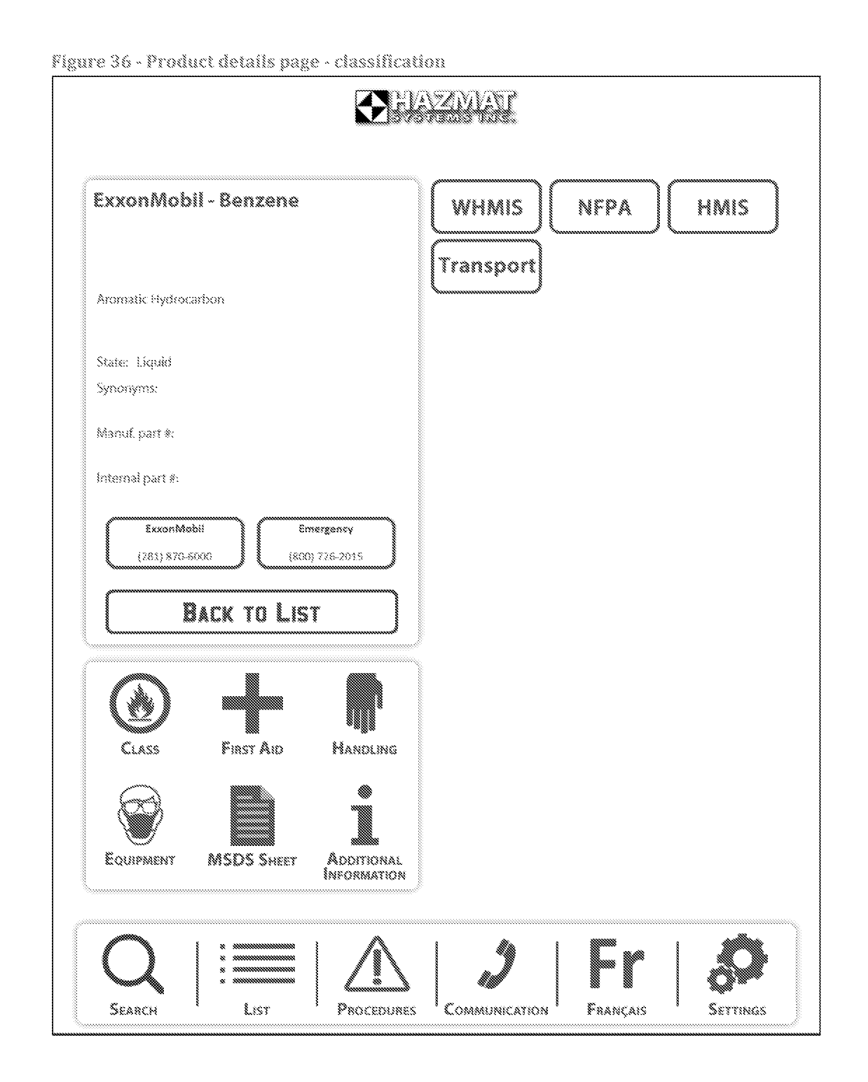

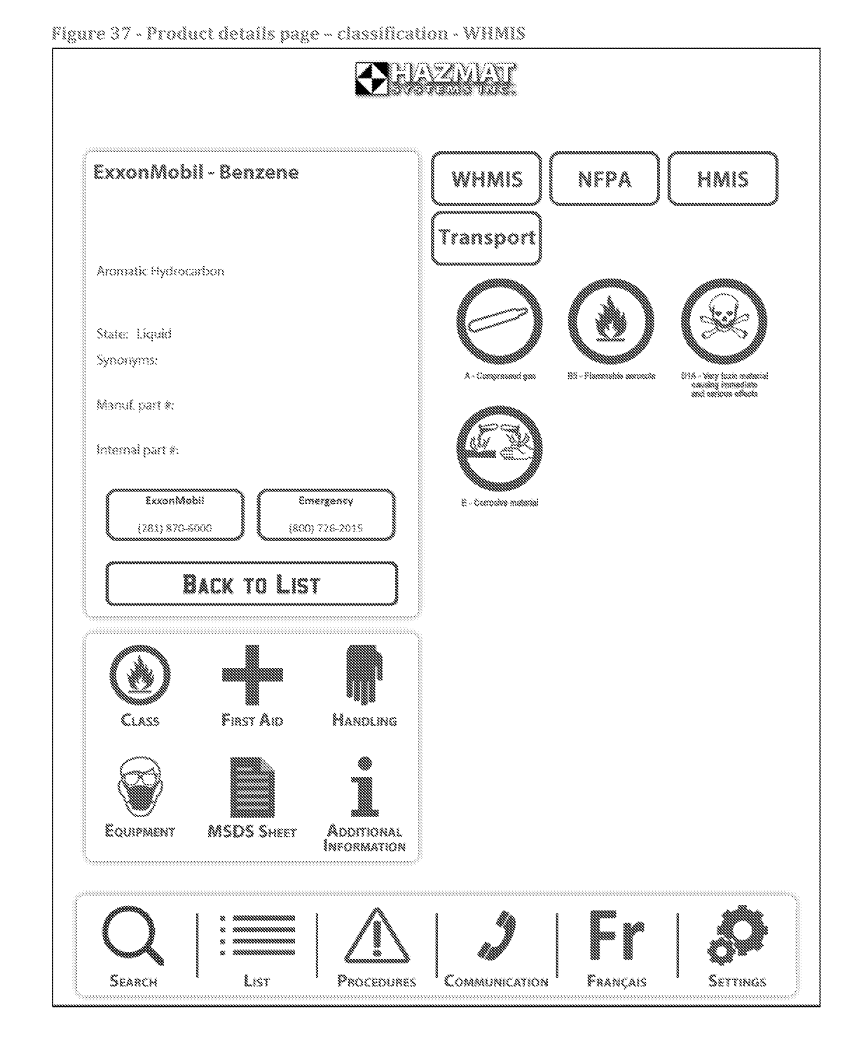

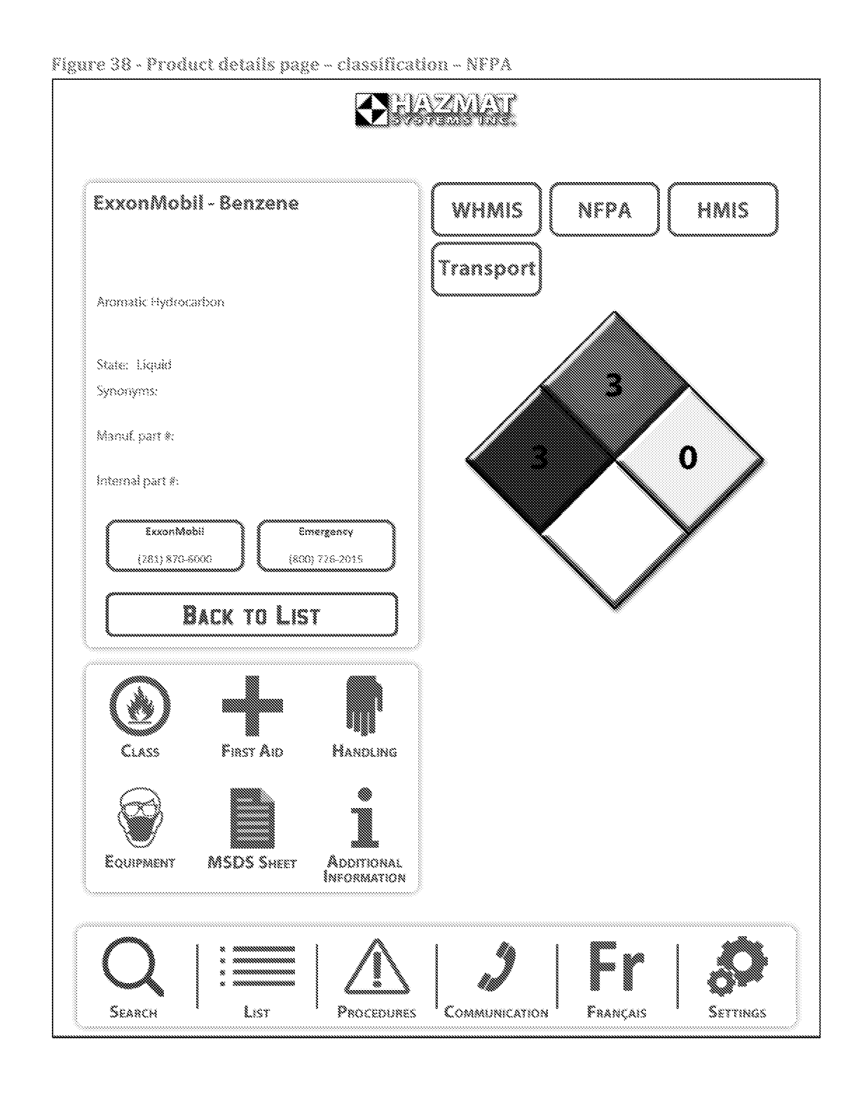

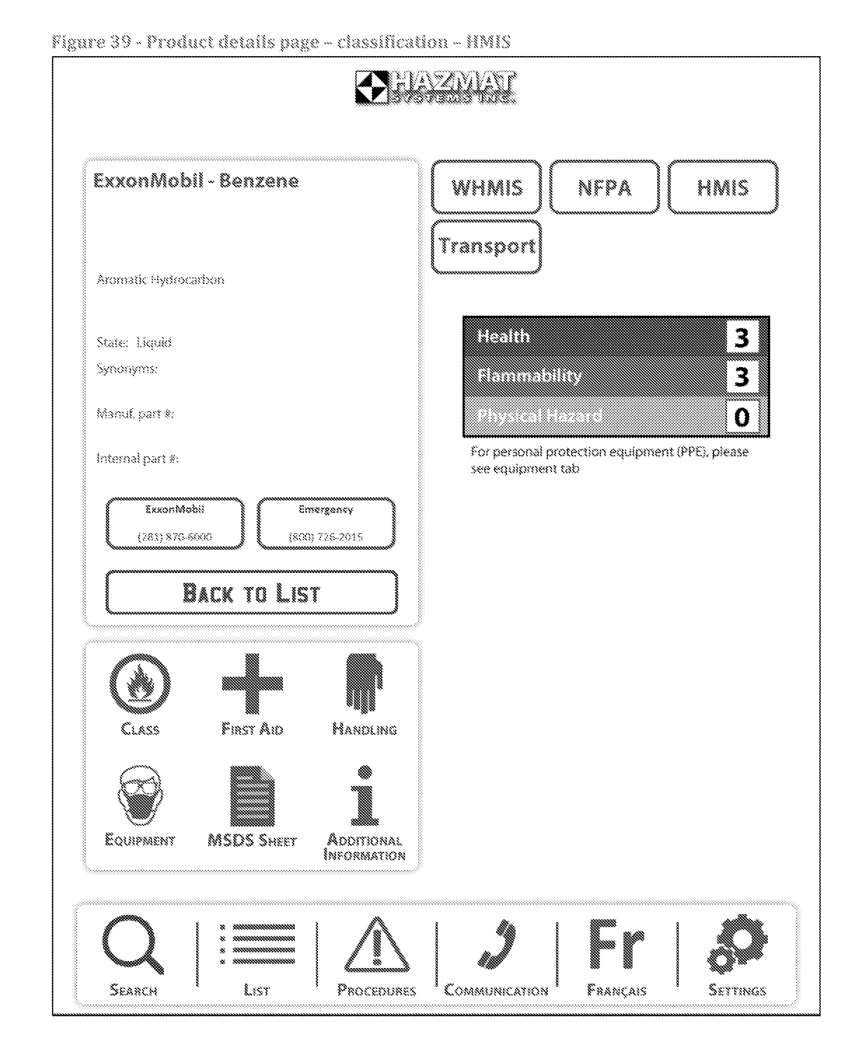

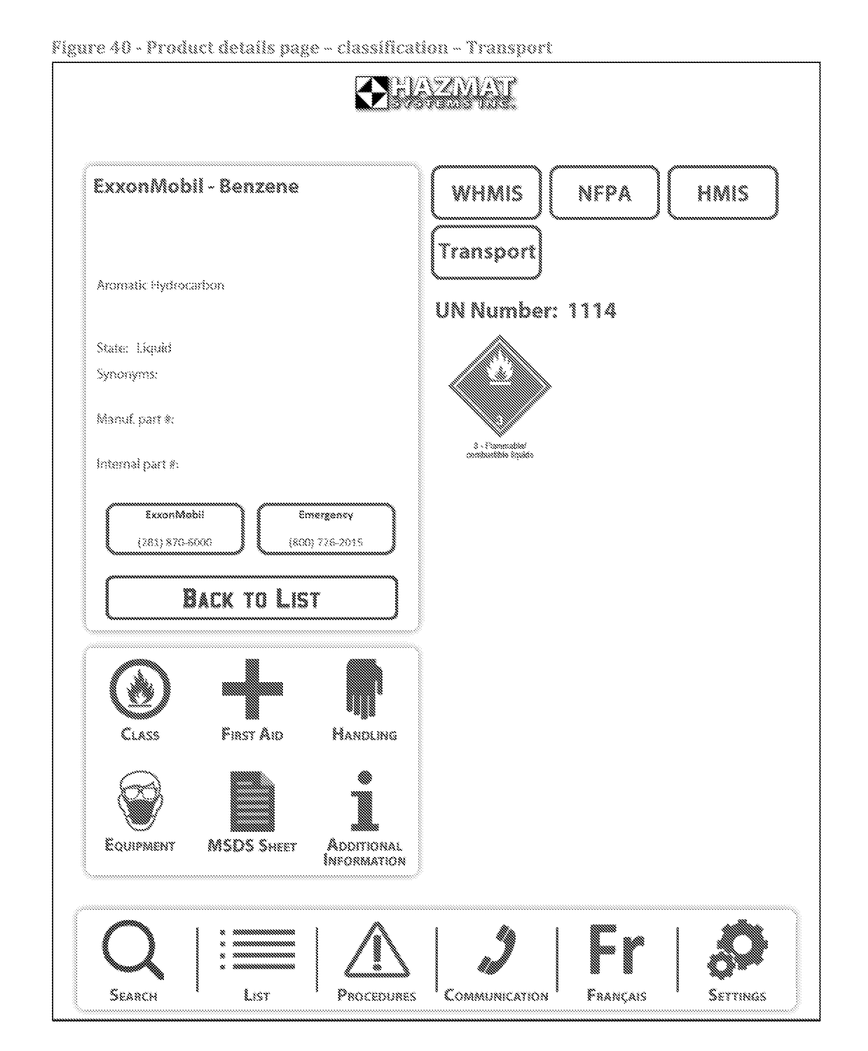

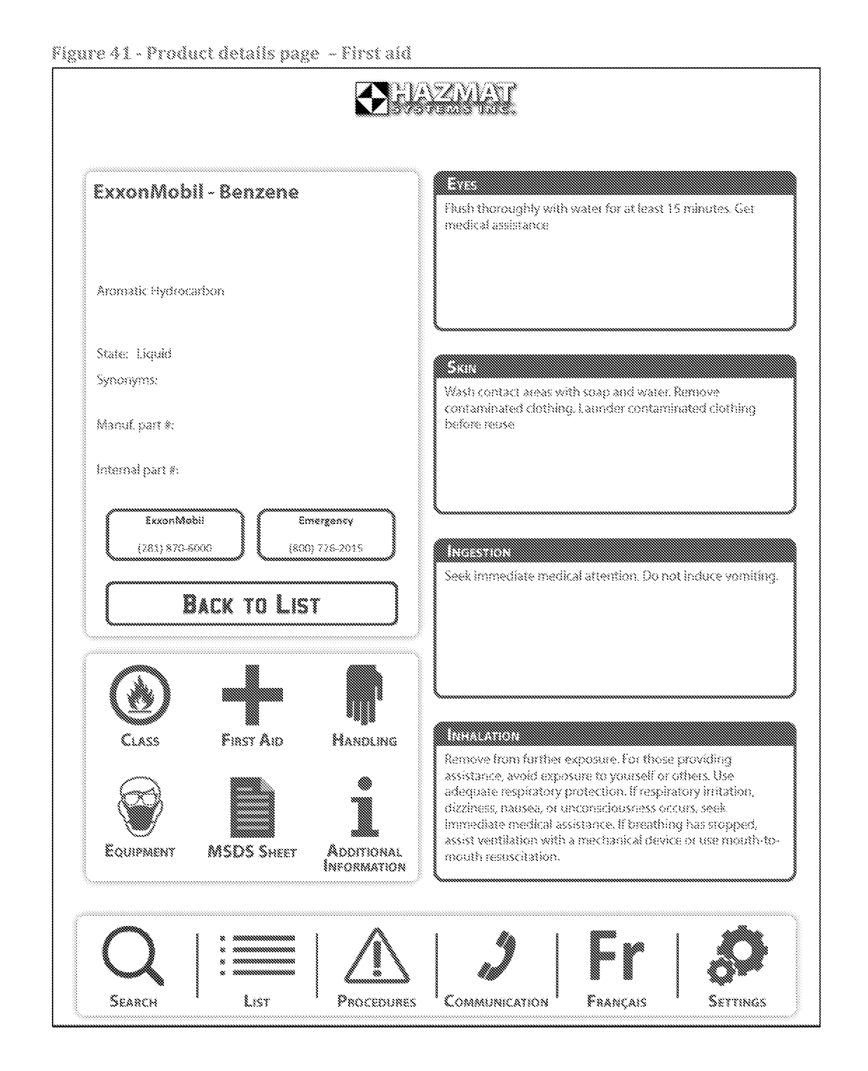

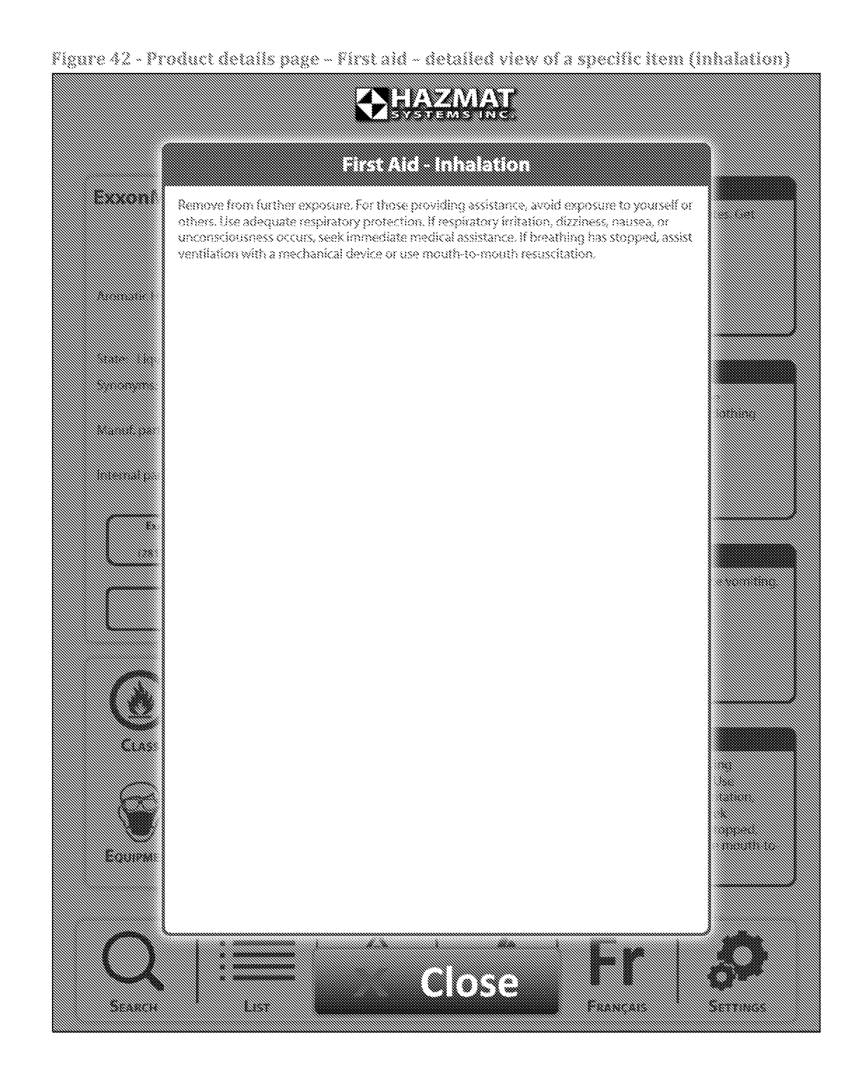

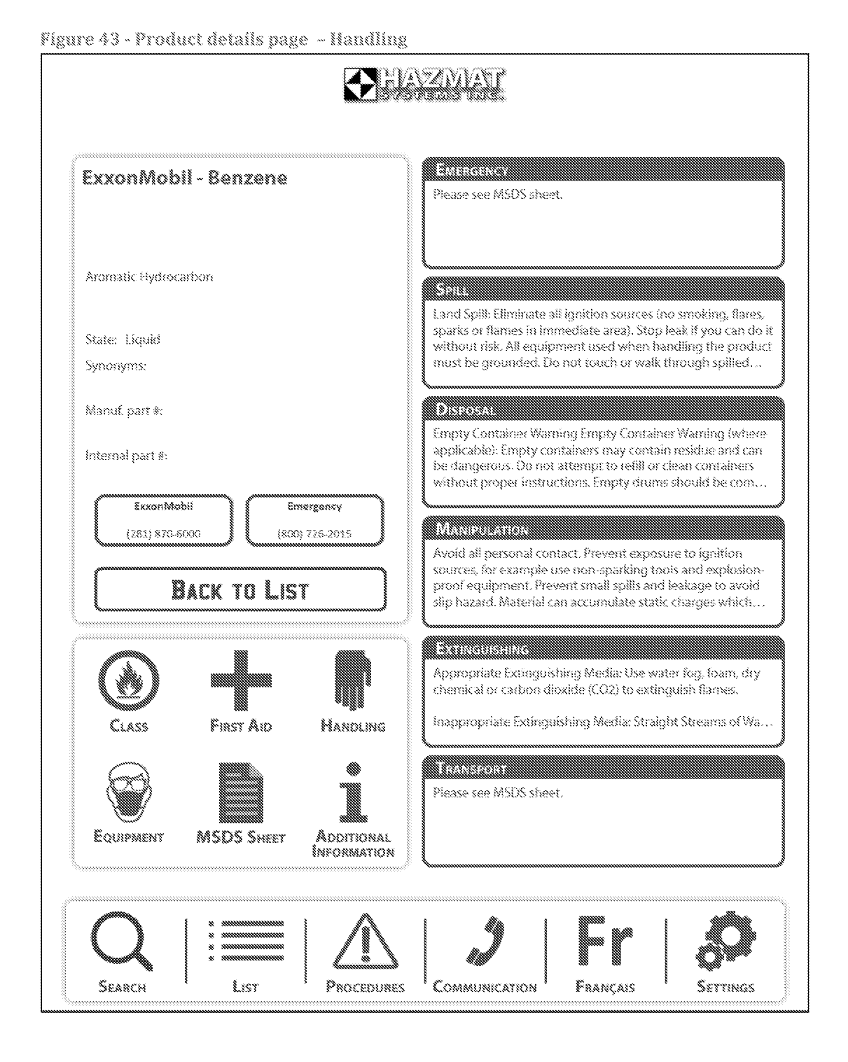

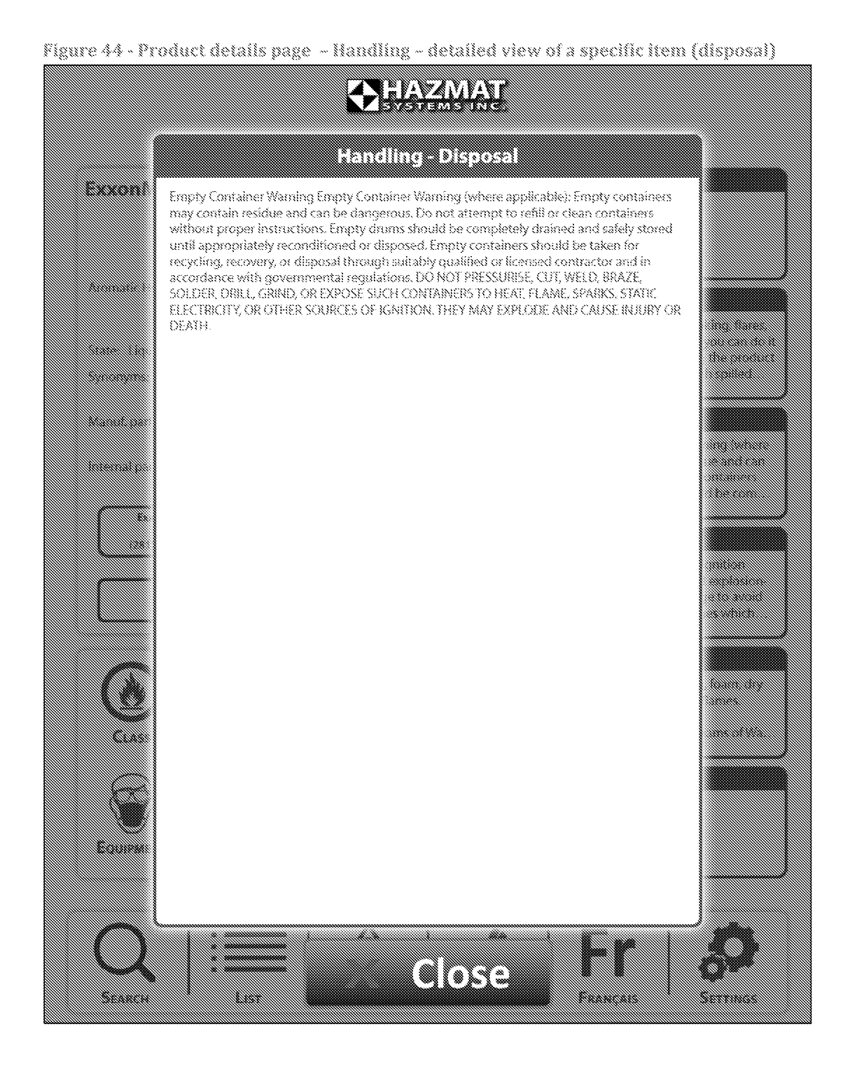

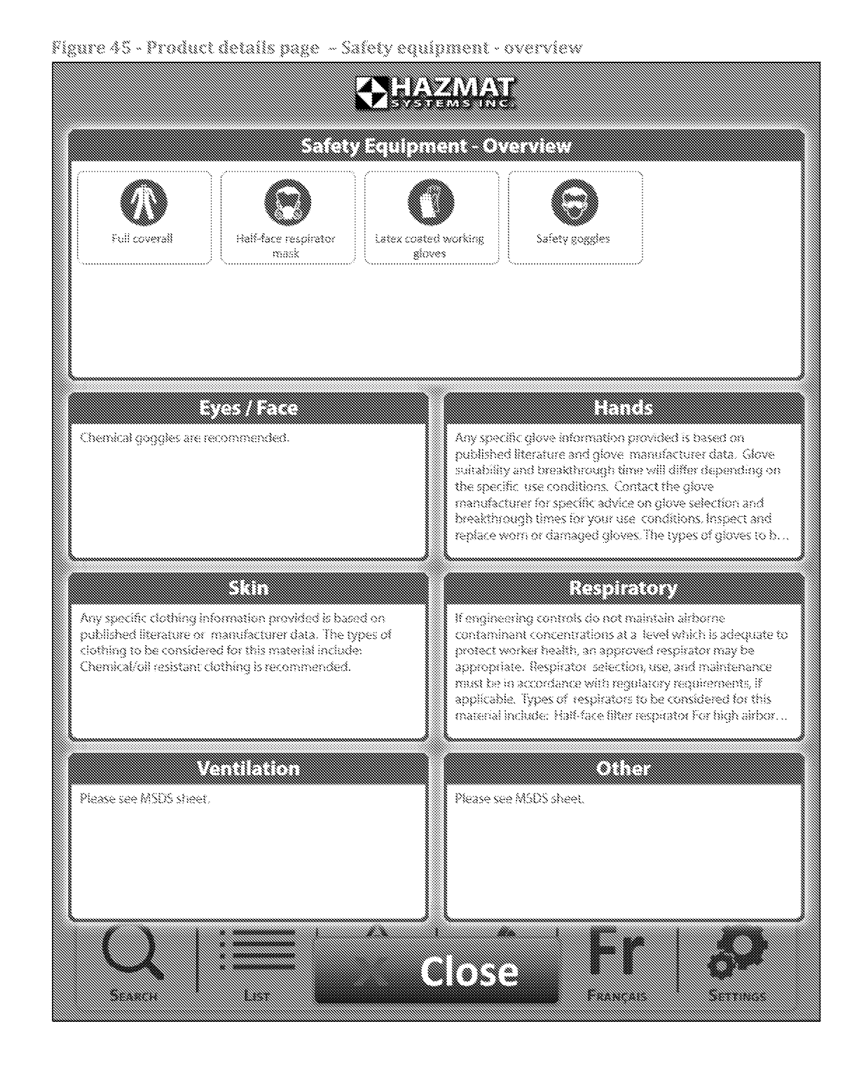

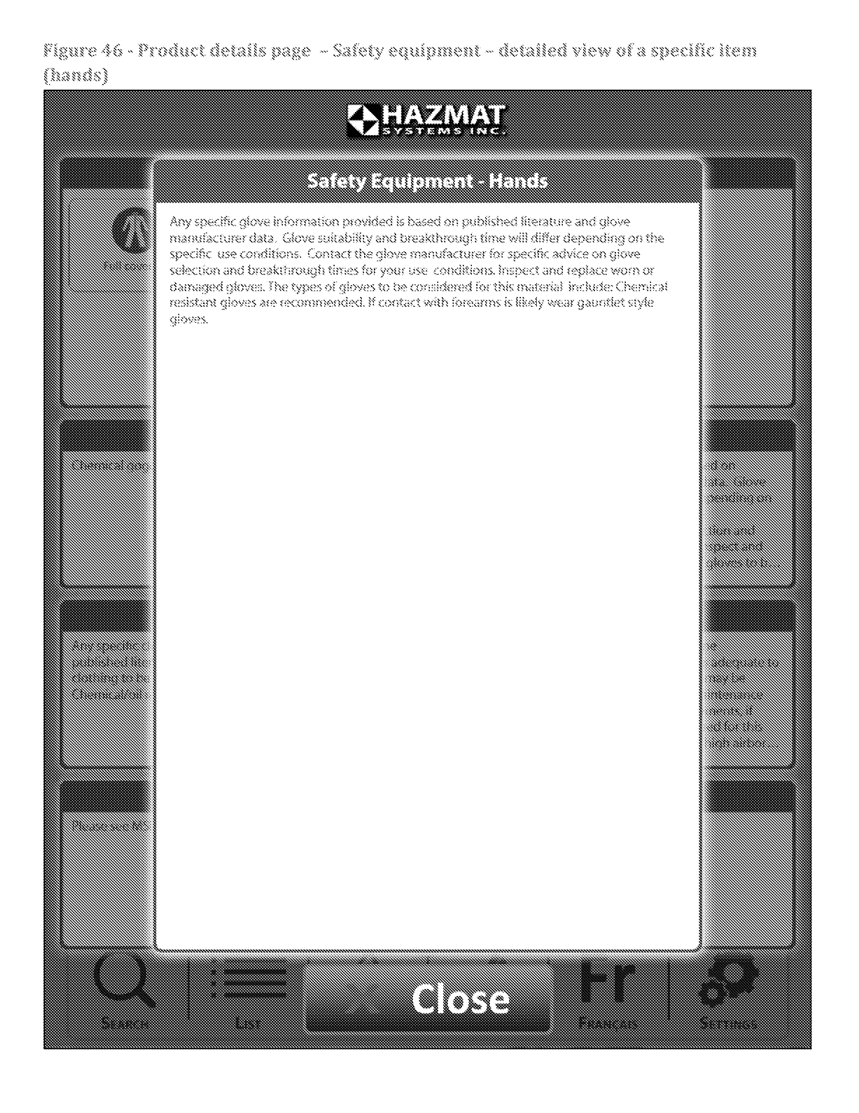

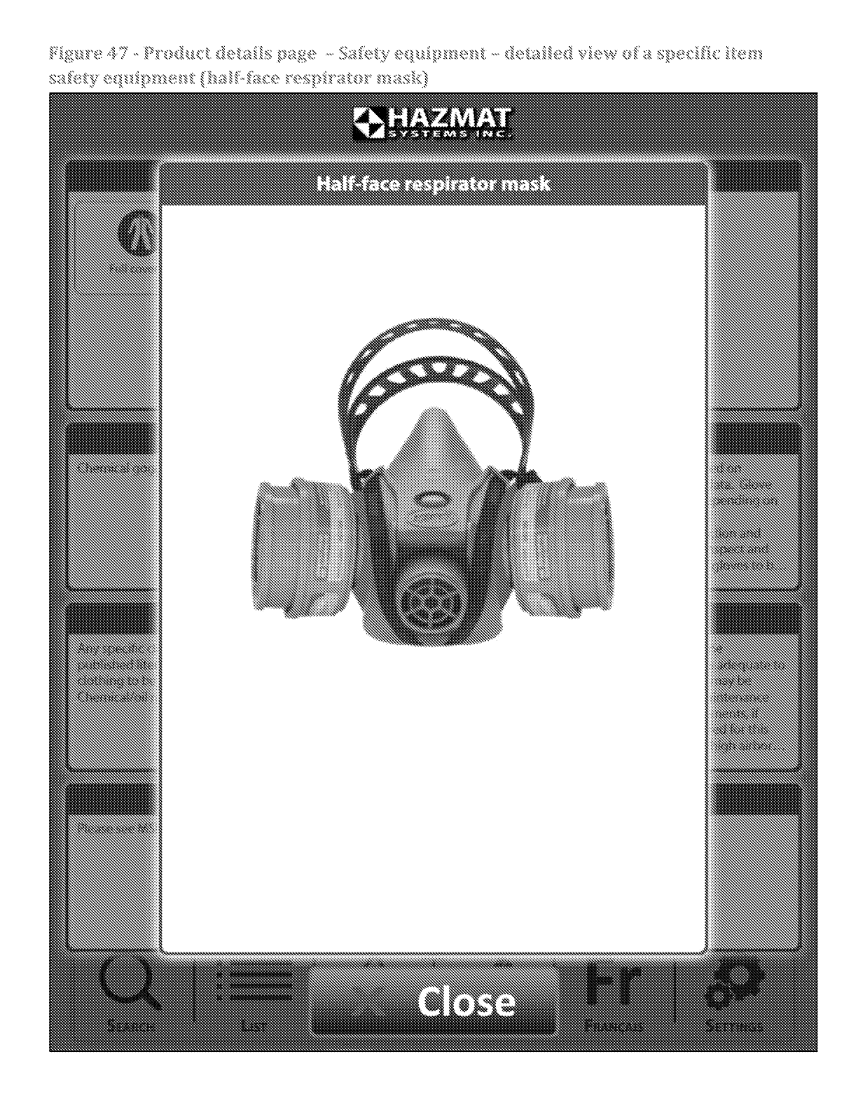

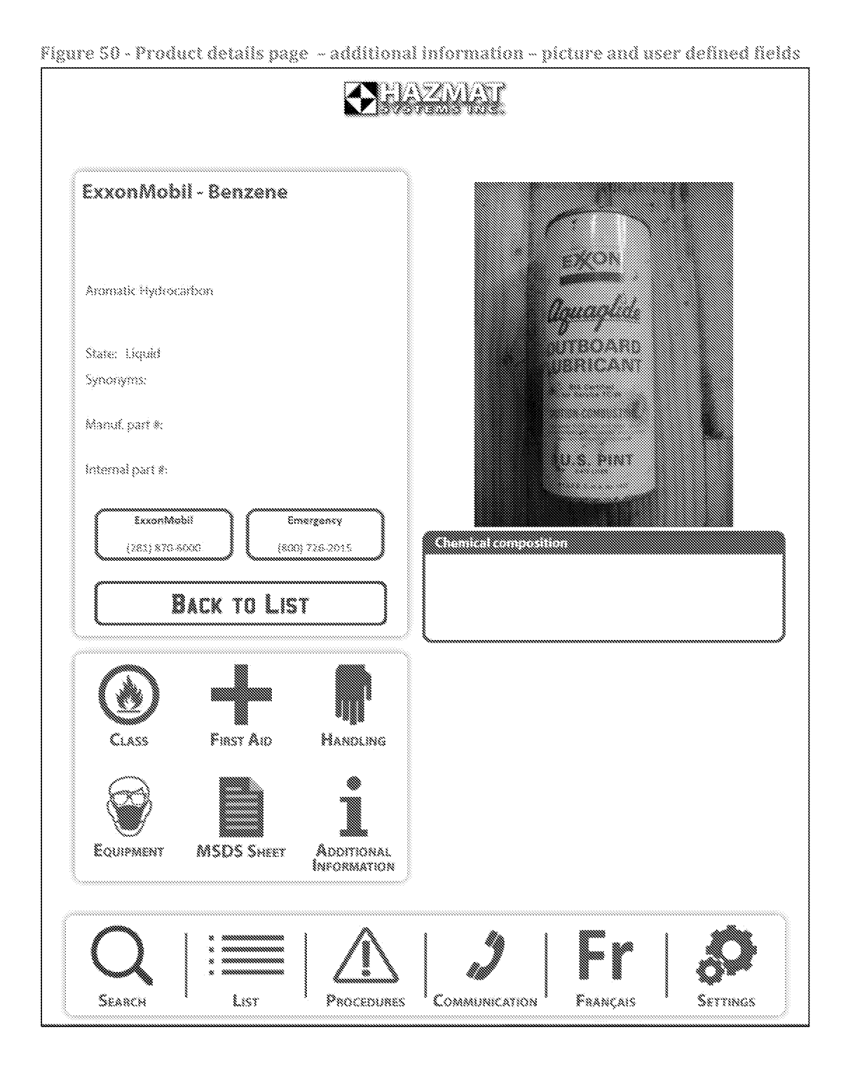

By clicking on the different subcategory icons (or buttons), users can access additional information on the screen, such as the classification of the product, whether it's WHMIS, NFPA, HMIS, Transport, GHS or any other classification (illustrated by the sample screenshots shown in FIGS. 36-40), first aid information (illustrated by the sample screenshots shown in FIGS. 41 and 42), handling information (illustrated by the sample screenshot shown in FIGS. 43 and 44), safety equipment information (illustrated by the sample screenshots shown in FIGS. 45-47), or even custom user defined fields and a picture of the product (illustrated by the sample screenshot shown in FIG. 50).

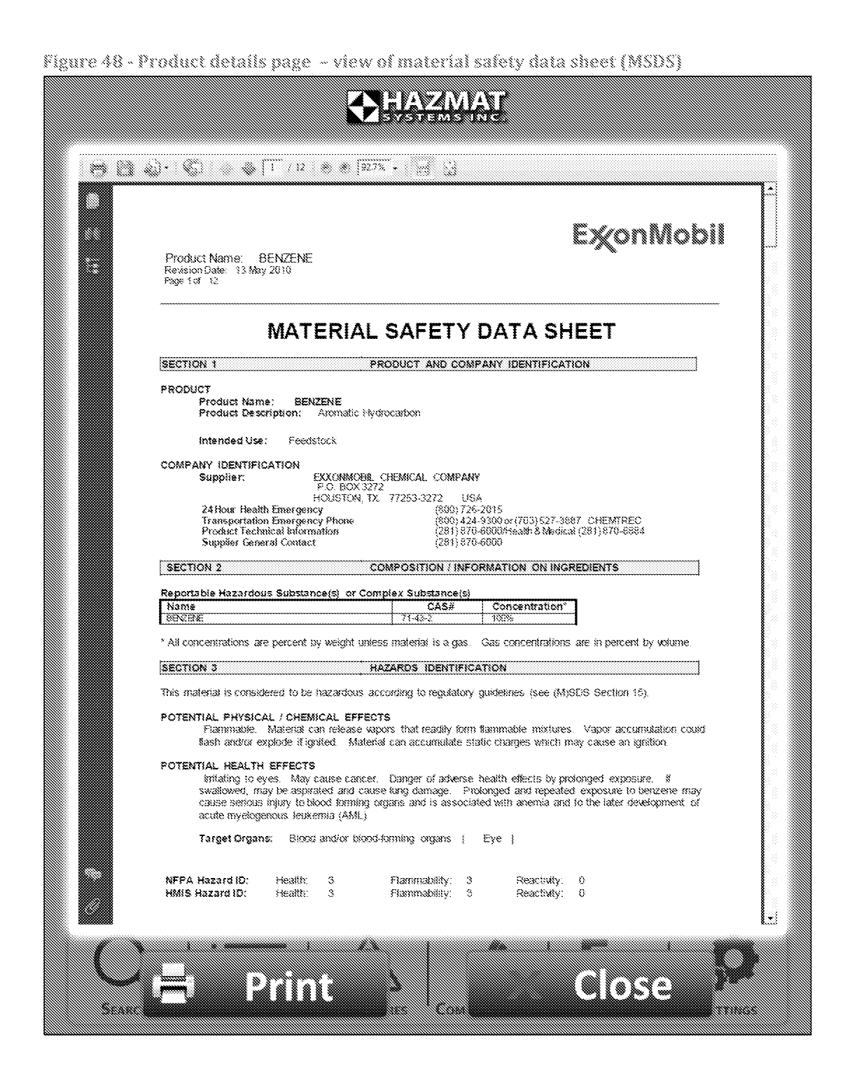

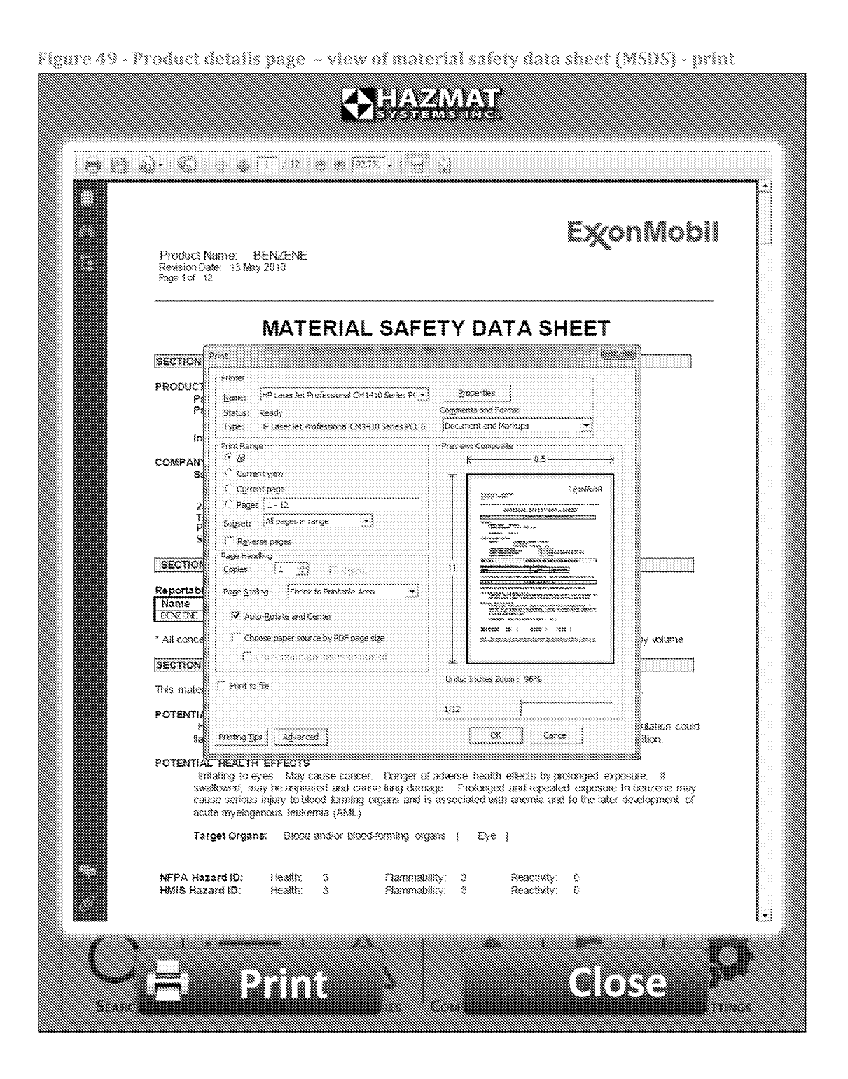

By selecting (e.g. clicking or pressing on) the MSDS Sheet icon, a pdf MSDS sheet is displayed on the screen to the user, as illustrated by the sample screenshot shown in FIG. 48. The user can easily scroll up and down the MSDS sheet by simply dragging the document up and down with his finger or by using the scrollbar on the right. The user can even print the MSDS to any network printer (see FIG. 49)

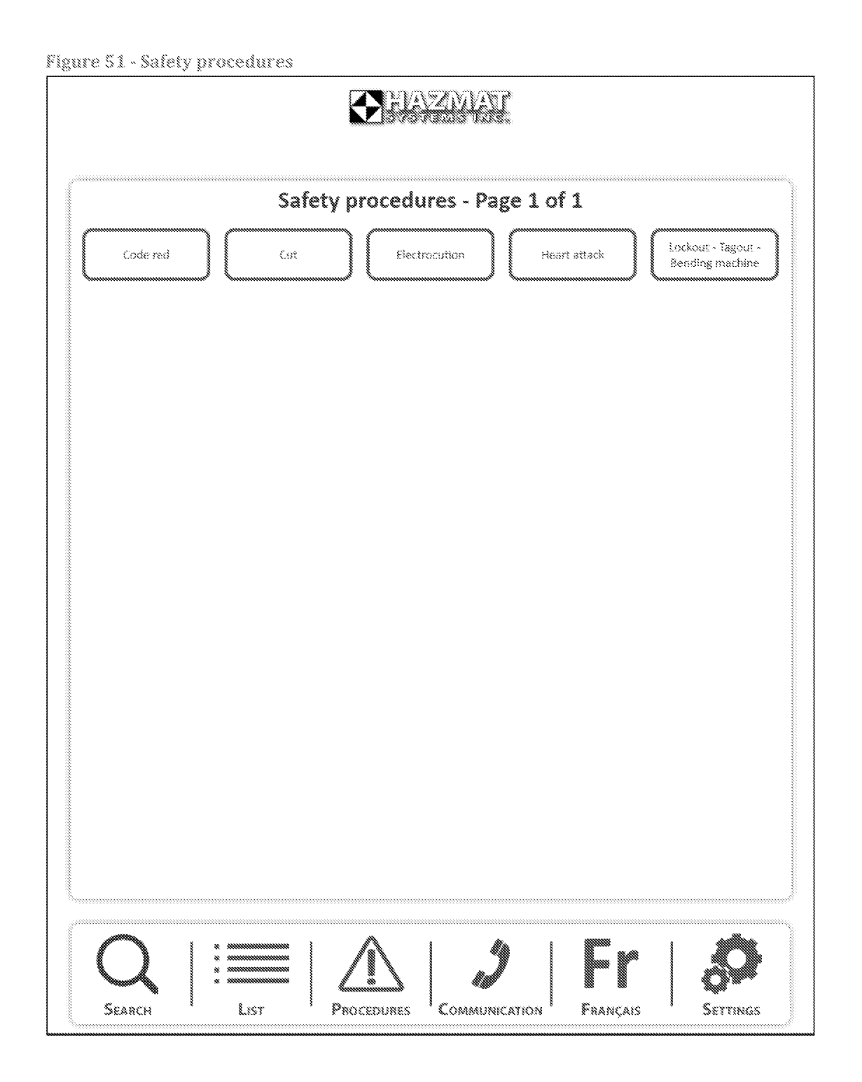

By clicking on the procedure button, the user is able to view all the emergency procedures that were entered in the online portion of the system, as illustrated in FIG. 51. These procedures can include emergency procedures, such as how to react is someone gets cut, electrocuted, falls, etc. It can also include safety procedures to follow to help prevent injury, such as lockout tagout information, information regarding working in heights, etc. There is also the possibility to add safety procedures for training purposes. The procedures section can be used by the employer to communicate any type of information they wish to convey to their employees.

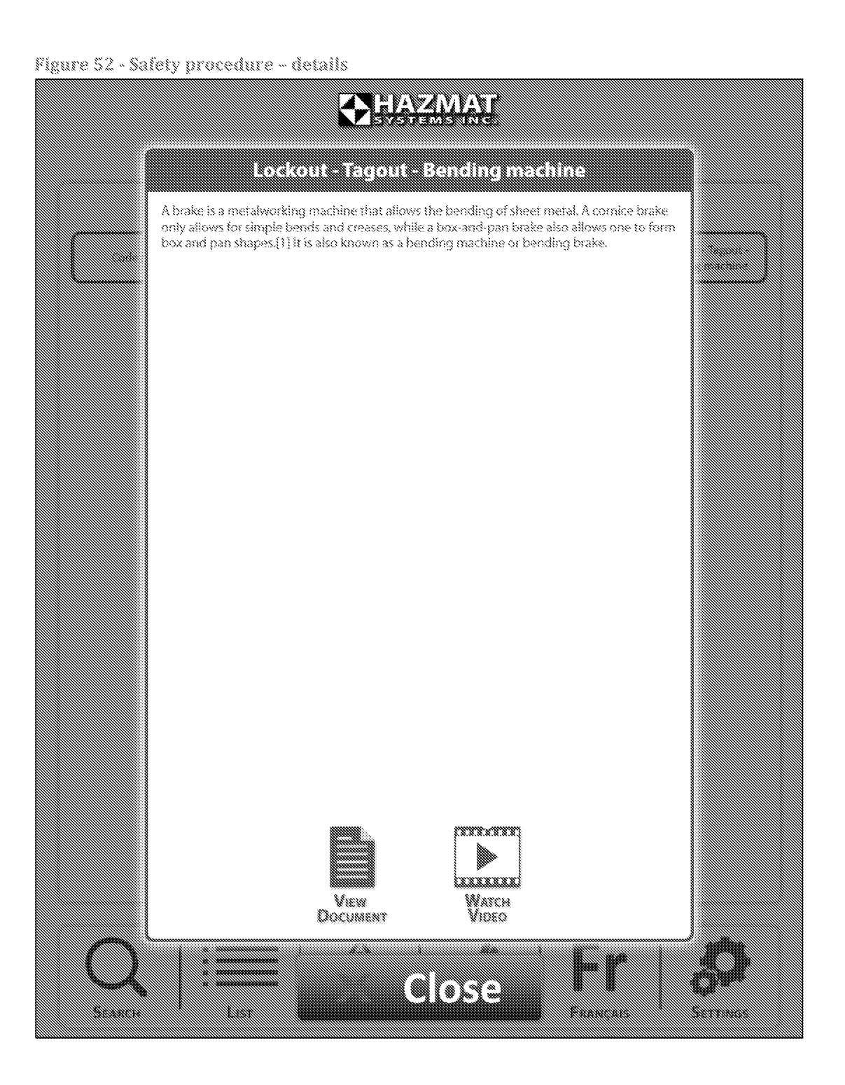

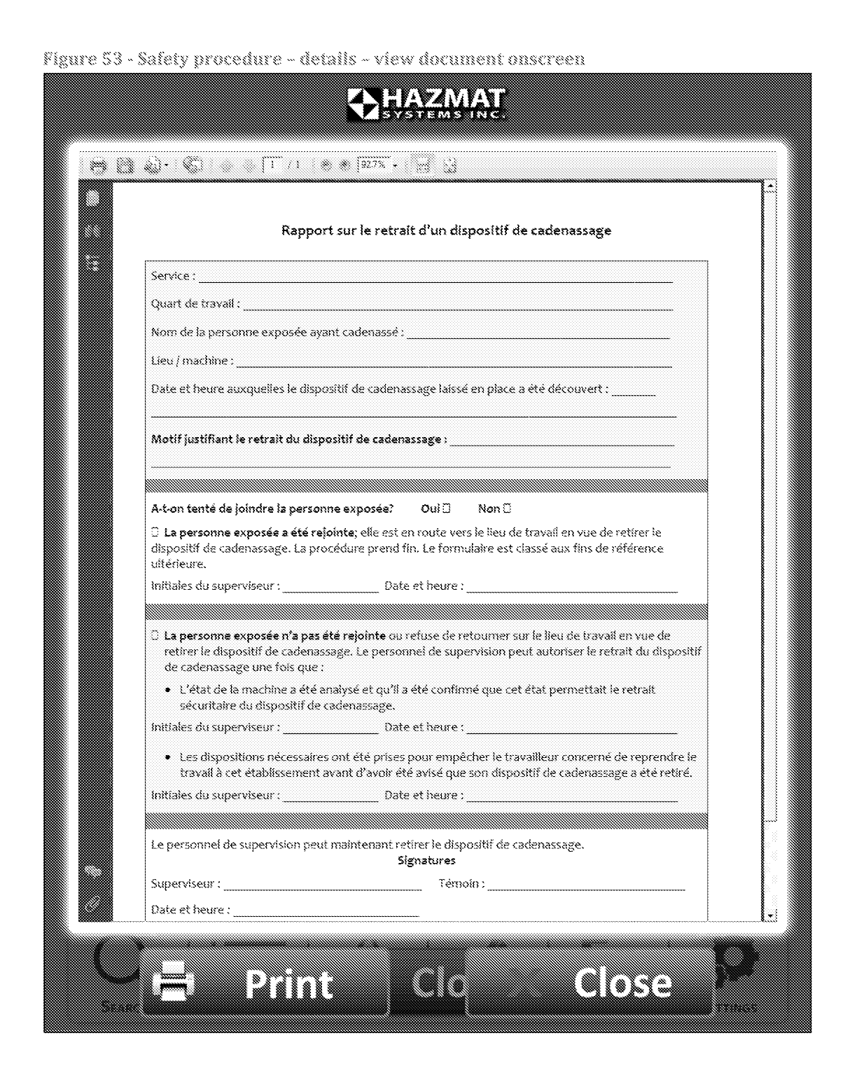

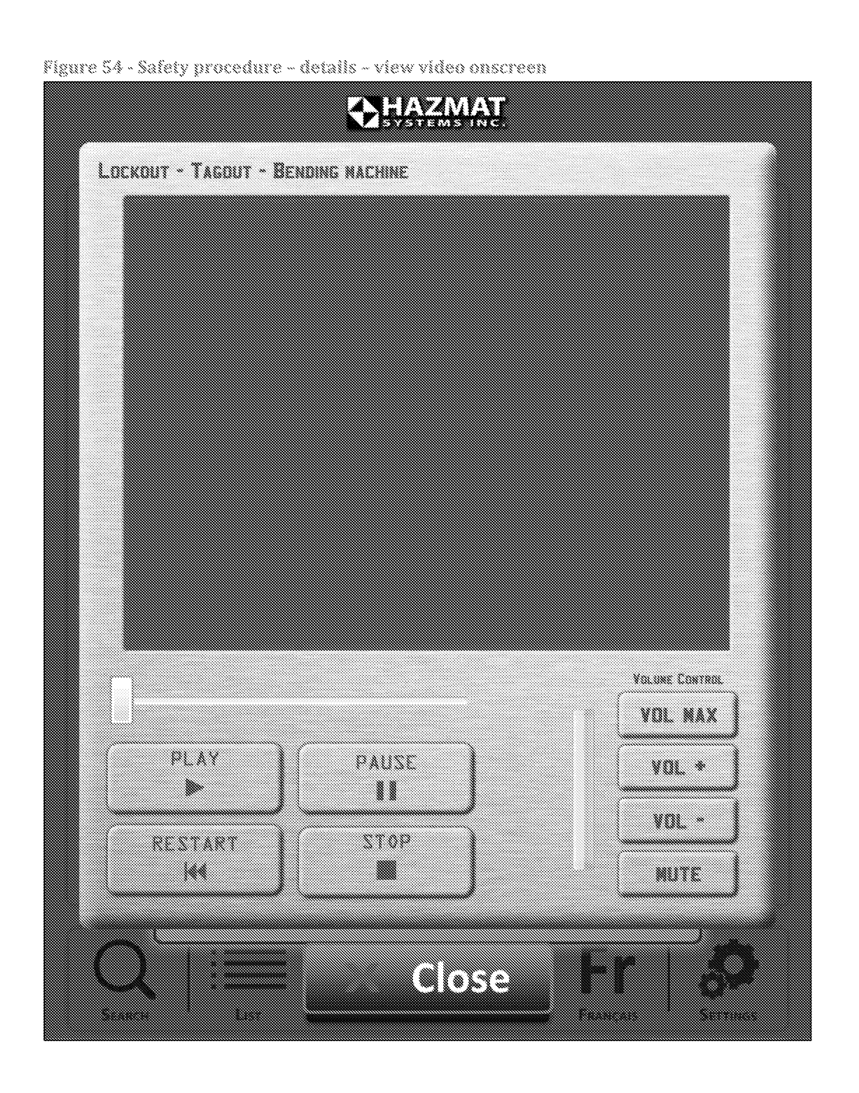

Each procedure may include several different components. Such components may for example consist of a text entered by a system administrator (see FIG. 52), a document uploaded in PDF format that will be visible onscreen and that can be handled and printed like an MSDS (see FIG. 53), and/or a video uploaded by a system administrator with controls (e.g. play, stop, restart, pause, a scrollbar, etc.) to navigate within the video and volume controls (see FIG. 54), among other possibilities.

In a specific, non-limiting example of implementation, when setting up a procedure, the system administrator may request that an employee enter a code after watching a short video, in order to identify himself. When that code is entered, an e-mail is sent to the administrator indicating that this employee has watched the entire video. Furthermore, a screen can also appear asking the employee multiple choice questions, to ensure that the user has indeed understood the video he has viewed, for purposes of tracking employee training. A similar set up may be defined for documents of a procedure that have to be viewed by employees. The system may register that a specific employee has either watched a video or viewed a document and store this viewing history information in the health and safety database (or server database). The system may also register and store in the database the employee's answers to the multiple choice questions, if need be.

By selecting the Communication icon at the bottom of the screen of the SafeStation, the user can access a central communications centre, from which he can get in touch with a number of emergency contacts as well as with any manufacturer with their number entered in the system.

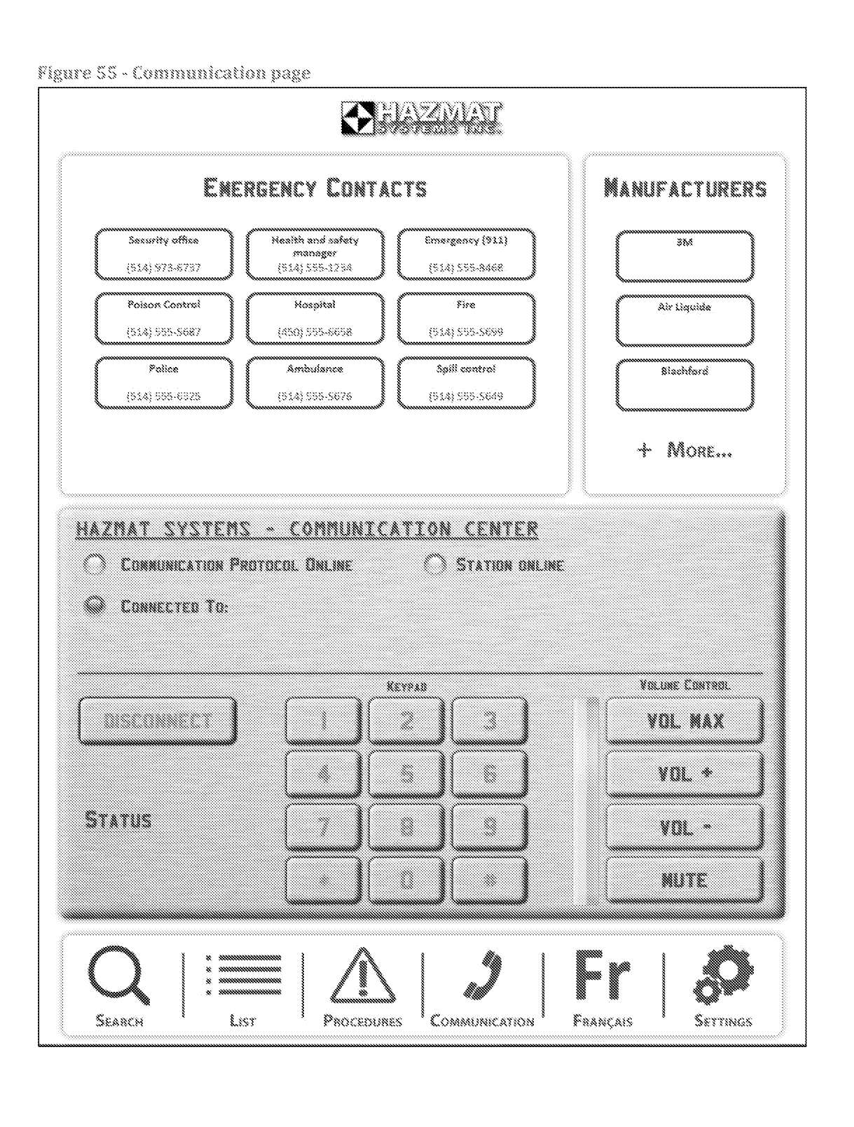

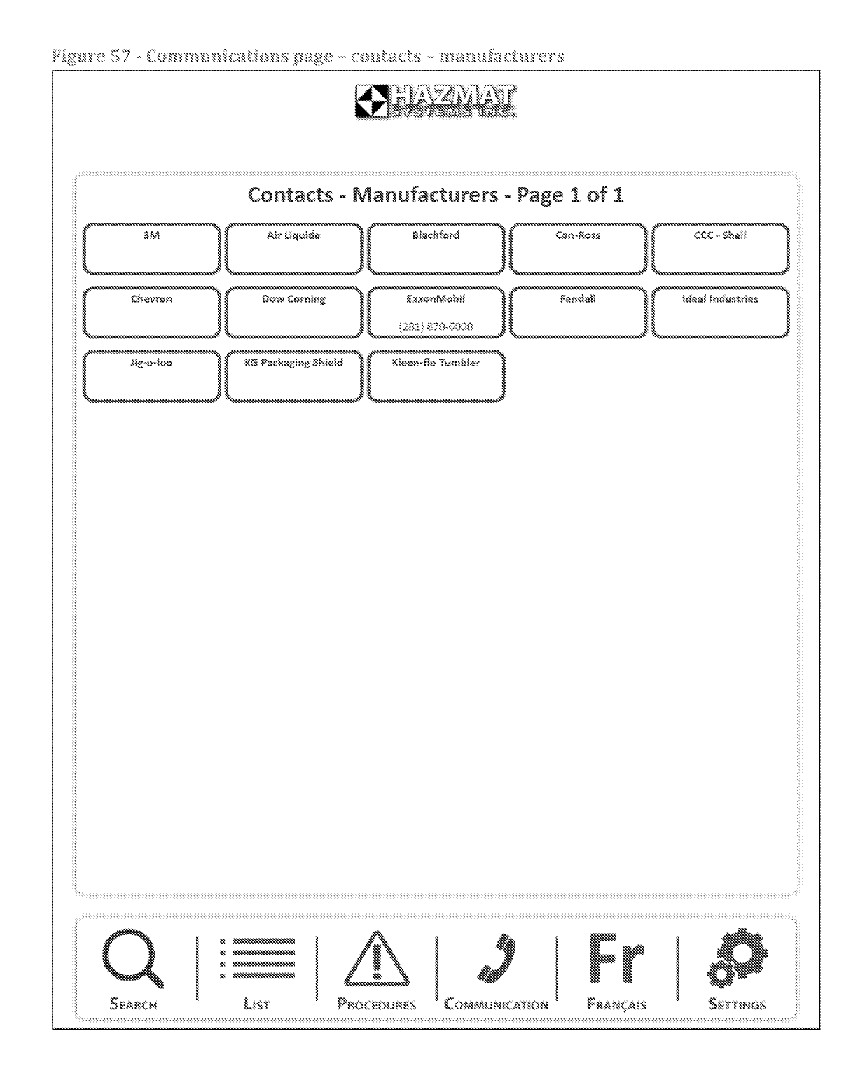

In the upper left portion of the screen (see FIG. 55), the user can see all the different emergency contacts, such as Emergency (911), poison control, hospital, fire, etc. There may also be company-related emergency contacts, as well as user-defined contacts that can be entered for every site/department. On the upper right portion of the screen (again see FIG. 55), the user can see a list of manufacturers, as well as access via a clickable control the entire list of manufacturers entered in the system if there are more than shown on the screen (see FIG. 57)

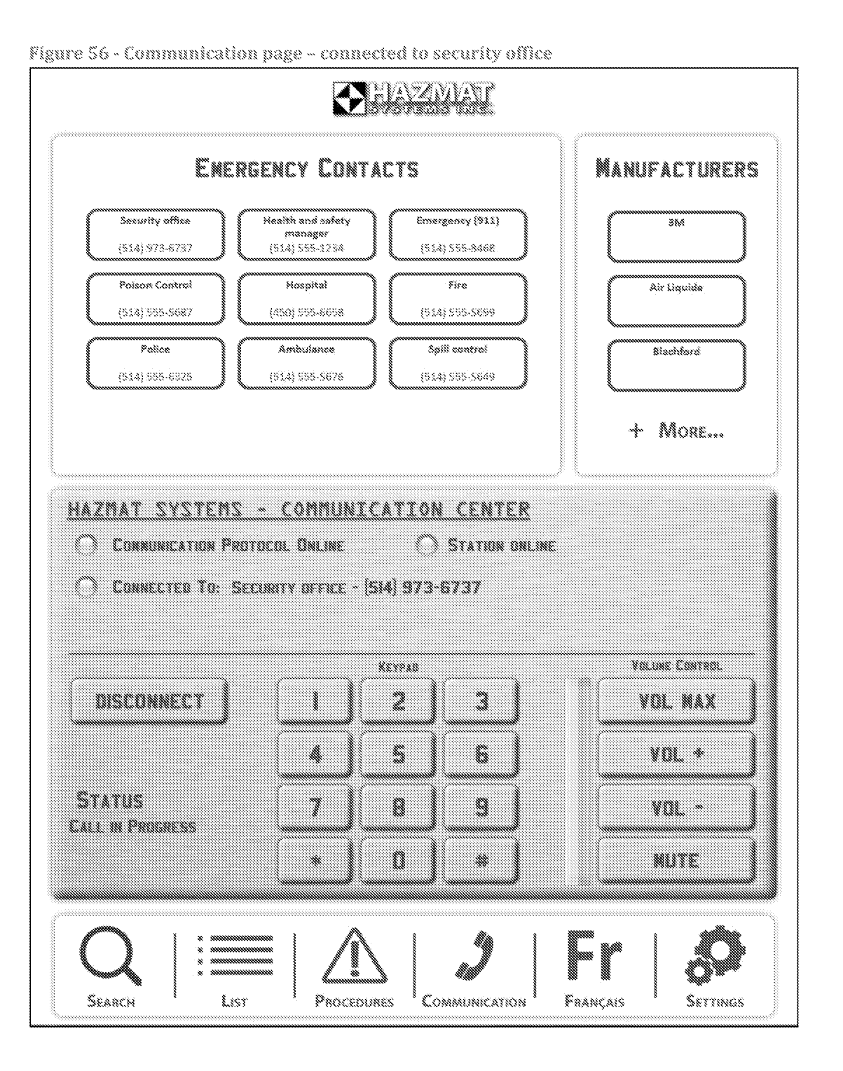

On the bottom of the communication screen is a communication center access panel. This access panel includes various controls that are either in an on or an off state, where these controls are representative of the current status of the communication center. In the non-limiting example shown in FIG. 55, the “communication protocol online” control indicates whether or not a communication software running in the background, such as Skype, is turned on; the “station online” control indicates whether or not this communication software is actually online; and the “connected to:” control indicates whether or not there is currently a call in progress and, if a call is in progress, who the system is currently connected to (see FIG. 56). The communication center access panel may also include controls for setting and/or adjusting the volume of the speaker in front of the SafeStation, a keypad that will become activated once a call is connected to allow users to either enter an extension or choose different options, as well as a disconnect button to terminate the call.

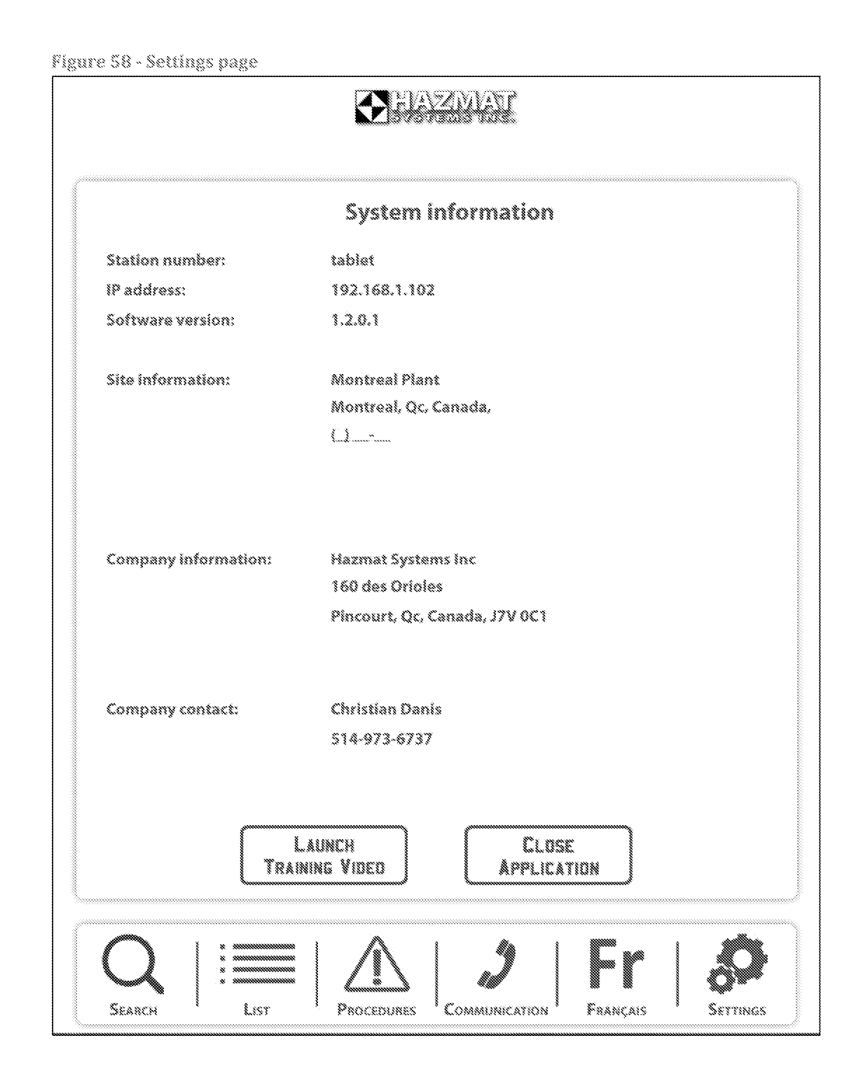

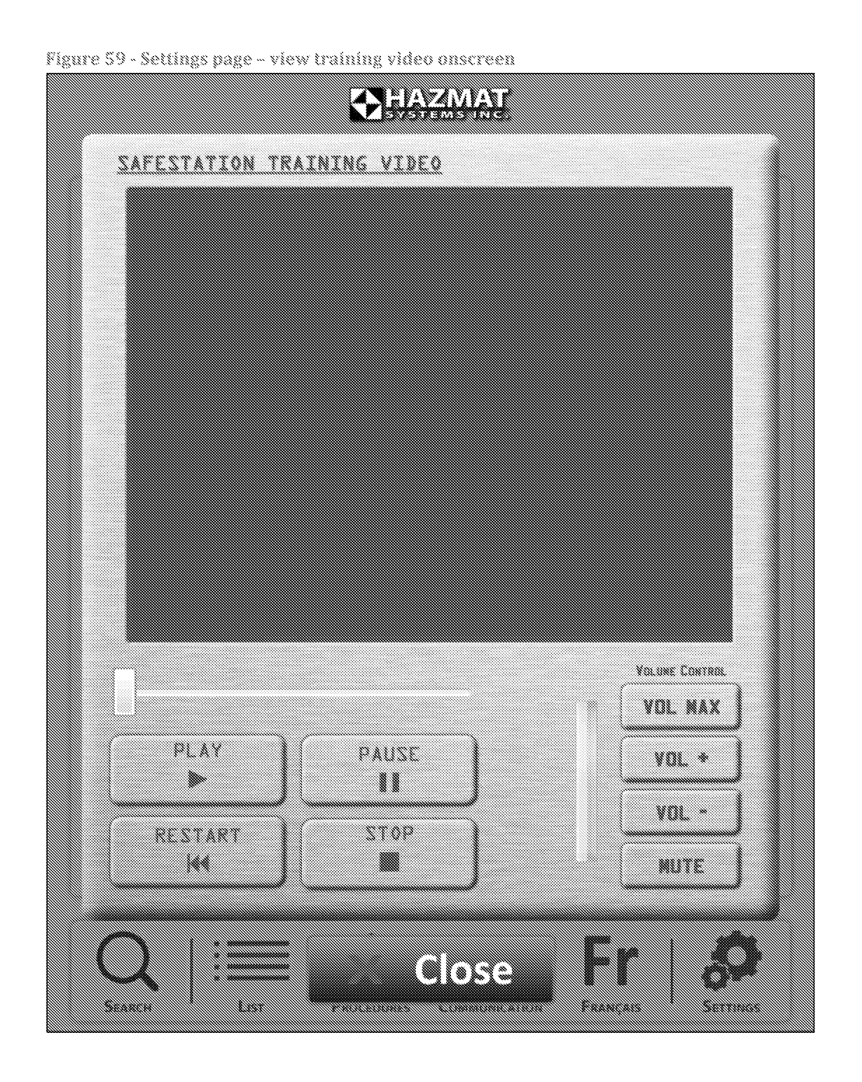

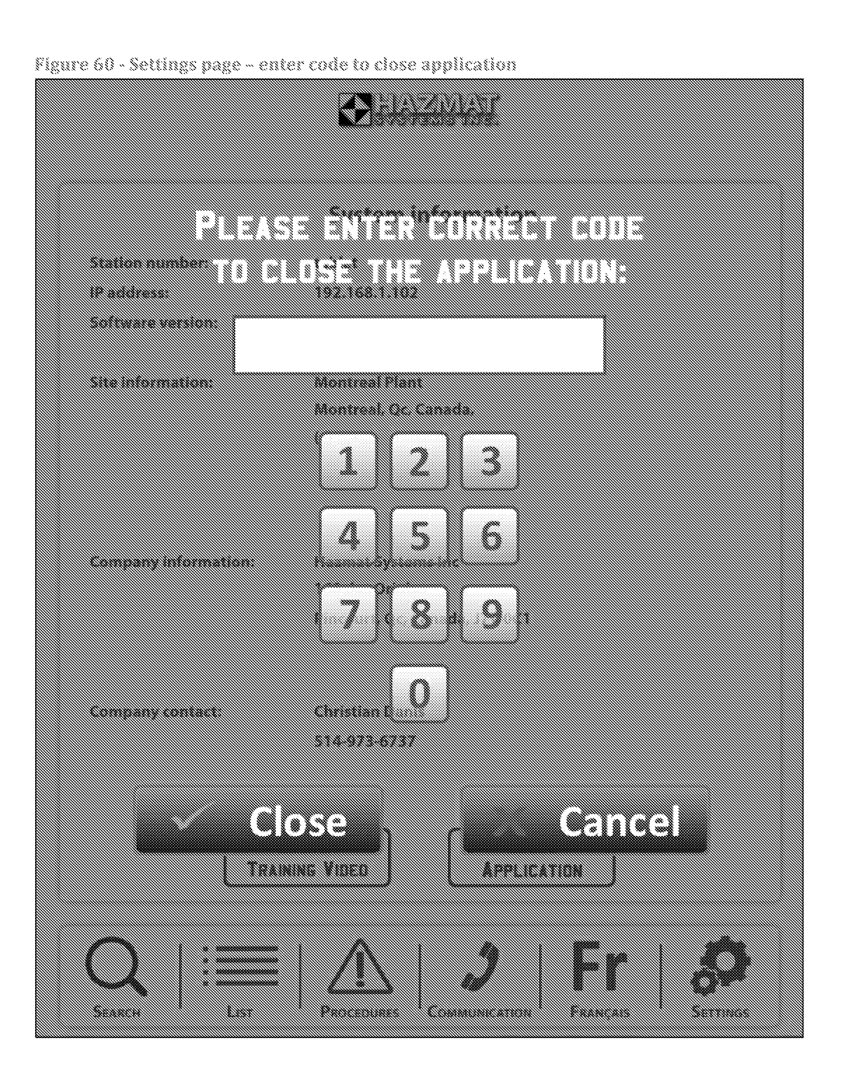

Finally, as illustrated by the sample screenshot shown in FIG. 58, the user can access a settings page by clicking on the settings icon on the bottom of the screen of the SafeStation. This settings page includes system information, site and company information, the name and phone number of the system administrator, and other station-specific information. The settings page also contains a control that will bring up the training video for this unit, allowing a user to simply watch a short video in order to learn how to use the SafeStation, as shown in FIG. 59. Also, in a non-limiting example, the settings page may allow a user to close the application running on the SafeStation, upon entering a validated password or code, as shown in FIG. 60. This password or code is given to authorized personnel in the company, and is a safety measure to ensure that only the authorized personnel can shut down the SafeStation.

At any time, the user can click on a language icon displayed on the screen of the SafeStation (e.g. French, English or Spanish depending on the current language) to change the language of the text displayed by the GUI.

Each SafeStation has its own local database, which updates itself automatically or manually with the latest information on the health and safety database (or server database) via a communications network, and which receives only the information pertinent to its site. This allows users to have access to critical information, even if the communication with the server database is unavailable.

### Emergency Services Interface

The emergency services interface is extremely similar to the standard web interface discussed above, with the difference that when a user logs in, the user must first choose which customer's information is to be consulted. The other difference is that each user is associated with a predefined level of security, which defines a restricted access for the respective user to products and site information (i.e. no access to manufacturer, supplier, users, stations, etc.). This interface can be used by emergency services, such as firefighters, police, Canutec, the poison control center, etc. to access a company's list of products and emergency contacts.

Although various embodiments have been illustrated, this was for the purpose of describing, but not limiting, the present invention. Various possible modifications and different configurations will become apparent to those skilled in the art and are within the scope of the present invention, which is defined more particularly by the attached claims.

What is claimed is:

1. A health and safety data management system, comprising:
a) a server in communication with a database storing data representative of health and safety information for a workplace of a customer;
b) at least one remote station connected to said server via a data communications network, said remote station located in the workplace and providing access to said respective health and safety information via said server, said remote station including:
i) a visual display;
ii) a processing unit coupled to said display, said processing unit operative to implement a graphical user interface for prompting a user to input commands and for displaying health and safety information to the user; and
iii) a housing unit containing said display and said processing unit, said housing unit formed of a resistant material capable to protect said display and said processing unit from environmental conditions in the workplace.

2. A health and safety data management system as defined in claim 1, wherein said visual display is a touchscreen.

3. A health and safety data management system as defined in claim 2, wherein said processing unit is responsive to user commands input via said touchscreen to search said data representative of health and safety information for specific data to be displayed to the user.

4. A health and safety data management system as defined in claim 3, wherein said remote station is located at a particular site in the workplace.

5. A health and safety data management system as defined in claim 4, wherein said database is a first database, said remote station further including a local second database storing a first subset of said data representative of health and safety information, said first subset of data being associated with said respective particular site in the workplace.

6. A health and safety data management system as defined in claim 1, wherein said server implements an emergency user interface module for providing remote emergency personnel with access to said data representative of health and safety information on a jurisdiction basis, said server including:
a) an input connected to the Internet for receiving a request signal from a remote computing device;
b) a processing module coupled to said input and responsive to said request signal to implement the emergency user interface module, said emergency user interface module being adapted for:
i) in a first viewing window, prompting a user for authentication data, said authentication data including identification of a particular customer;
ii) in a second viewing window, displaying a second subset of said data representative of health and safety information, said second subset of data being associated with said particular customer;
c) an output coupled to said processing module, said output operative to transmit a signal over said Internet to said remote computing device for causing said remote computing device to display said emergency user interface module on a local display unit.

7. A health and safety data management system as defined in claim 1, wherein said server implements an administrator user interface module for editing the health and safety data stored in the database of a particular customer, said server including:
a) an input connected to the Internet for receiving a request signal from a remote computing device;
b) a processing module coupled to said input and responsive to said request signal to implement the administrator user interface module, said administrator user interface module being adapted for:
i) in a primary viewing window, prompting a user for authentication data, said authentication data including identification of the particular customer and of the user;
ii) in at least one secondary viewing window, displaying said data representative of health and safety information associated with the customer, and providing a plurality of selectable controls via which the user can edit and update said data;
c) an output coupled to said processing module, said output operative to transmit a signal over said Internet to said remote computing device for causing said remote computing device to display said administrator user interface module on a local display unit.

8. A health and safety data management system as defined in claim 1, wherein said data representative of health and safety information includes textual data, audio data and video data.

9. A health and safety data management system as defined in claim 1, wherein said processing unit of said remote station is further operative to validate viewing of a particular health and safety information element by the user, whereby said processing unit prompts the user for identification after displaying said health and safety information element on said display of said remote station.

10. A health and safety data management system as defined in claim 9, wherein validation of viewing of said health and safety information element includes prompting the user to answer at least one question regarding said health and safety information element.
